(19) United States
(12) Patent Application Publication
(10) Pub. No.: US 2019/0119523 A1
(43) Pub. Date: Apr. 25, 2019

(54) POLISHING COMPOSITION, METHOD FOR PRODUCING SAME, AND MAGNETIC POLISHING METHOD

(71) Applicant: FUJIMI INCORPORATED, Kiyosu-shi, Aichi (JP)

(72) Inventors: Shuichi TAMADA, Aichi (JP); Hitoshi MORINAGA, Aichi (JP); Shota HISHIDA, Aichi (JP); Daisuke YASUI, Aichi (JP)

(73) Assignee: FUJIMI INCORPORATED, Kiyosu-shi, Aichi (JP)

(21) Appl. No.: 16/089,144

(22) PCT Filed: Mar. 23, 2017
(86) PCT No.: PCT/JP2017/011758

§ 371 Date: Sep. 27, 2018

(30) Foreign Application Priority Data
Apr. 1, 2016 (JP) 2016-074554
Mar. 8, 2017 (JP) 2017-044074

(51) Int. Cl. C09G 1/02; B24B 1/00

(52) U.S. Cl. CPC C09G 1/02; B24B 37/044; B24B 1/005

(57) ABSTRACT

Provided are a polishing composition, in which oxidation of magnetic particles hardly occurs, and a magnetic polishing method. The polishing composition (1) contains magnetic particles, an antioxidant for suppressing oxidation of the magnetic particles, and water. A magnetic field is applied to the polishing composition (1) to form a magnetic cluster (3) that contains the magnetic particles, and the magnetic cluster (3) is brought into contact with an object (5) to be polished, to polish the object (5) to be polished.

### TECHNICAL FIELD

The present invention relates to a polishing composition, a method for producing the same, and a magnetic polishing method.

### BACKGROUND ART

As a polishing method for finishing a surface of a material with a high accuracy (for example, mirror-finishing), a magnetic polishing method is known. The magnetic polishing method is a polishing method in which a slurry obtained by mixing nonmagnetic abrasive particles with a functional fluid responsive to a magnetic field such as a magnetic fluid, a magnetic viscous fluid, and a magnetic mixed fluid is used as a polishing composition, and polishing is carried out by applying a magnetic field to the polishing composition to form a magnetic cluster and bringing the magnetic cluster as a polishing tool into contact with an object to be polished.

For example, PTL 1 discloses a magnetic polishing method using a polishing composition that contains magnetic particles, abrasive particles, a stabilizer for stabilizing colloid-size particles, an additive for modulating viscosity, and a carrier fluid. In addition, PTL 2 discloses a magnetic polishing method using a particle-dispersed mixed functional fluid as a polishing composition.

However, in the polishing compositions disclosed in PTLs 1 and 2, there is a problem that iron powders which are magnetic particles are oxidized in the polishing compositions due to being brought into contact with water or the like, and thus a polishing performance of the polishing compositions is decreased over time. In addition, since hydrogen is generated due to the oxidation of iron powders, there is also a problem in safety.

In PTLs 3 and 4, in order to suppress oxidation of magnetic particles, techniques for covering a surface of each of the magnetic particles with a protective layer such as a polymer material are disclosed. However, it cannot be said that effects thereof are sufficient. In addition, there is also a problem that cost and labor are required to cover the magnetic particles with the protective layer.

### CITATION LIST

### Patent Literature

PTL 1: JP 2002-544318 T

PTL 2: JP 2010-214505 A

PTL 3: JP 2005-40944 A

PTL 4: JP 2007-326183 A

### SUMMARY OF INVENTION

### Technical Problem

Therefore, an object of the present invention is to solve the problems in the related art as described above and to provide a polishing composition in which oxidation of magnetic particles hardly occurs, a method for producing the same, and a magnetic polishing method.

### Solution to Problem

In order to achieve the aforementioned object, a polishing composition according to an aspect of the present invention contains magnetic particles, an antioxidant for suppressing oxidation of the magnetic particles, and water.

In addition, a magnetic polishing method according to another aspect of the present invention is a magnetic polishing method for polishing an object to be polished by using the polishing composition according to the above aspect, which includes applying a magnetic field to the polishing composition to form a magnetic cluster that contains the magnetic particles and bringing the magnetic cluster into contact with the object to be polished, to polish the object to be polished.

Furthermore, a method for producing a polishing composition according to yet another aspect of the present invention is a method for producing the polishing composition according to the above aspect, which includes mixing a first component containing magnetic particles and a second component containing water.

### Advantageous Effects of Invention

In the polishing composition according to the present invention, oxidation of the magnetic particles hardly occurs. In addition, in the method for producing a polishing composition according to the present invention, it is possible to obtain a polishing composition in which oxidation of magnetic particles hardly occurs. Furthermore, in the magnetic polishing method according to the present invention, since oxidation of the magnetic particles hardly occurs, it is possible to carry out polishing for finishing the object to be polished with a high accuracy.

### BRIEF DESCRIPTION OF DRAWINGS

FIG. 1 is a view for explaining an embodiment of a magnetic polishing method according to the present invention.

### DESCRIPTION OF EMBODIMENTS

An embodiment of the present invention will be described in detail. It should be noted that the following embodiment shows one example of the present invention, and the present invention is not limited to the present embodiment. In addition, it is possible to add various modifications or improvements to the following embodiment, and modes in which such modifications or improvements have been added are also allowed to be included in the present invention.

A polishing composition of the present embodiment contains magnetic particles, an antioxidant for suppressing oxidation of the magnetic particles, and water. In a case where a magnetic field is applied to the polishing composition of the present embodiment, the magnetic particles functioning as abrasives are arranged in a chain shape along a magnetic force line to form a magnetic cluster.

Since the magnetic cluster functions as a polishing tool, it is possible to use the polishing composition of the present embodiment for a magnetic polishing method. That is, in a case where the magnetic cluster is brought into contact with the object to be polished and a relative movement is made therebetween while applying a magnetic field to the polishing composition of the present embodiment, it is possible to carry out polishing for finishing the object to be polished with a high accuracy (for example, mirror-finishing).

For example, it is possible to use the polishing composition of the present embodiment for a magnetic polishing method using a polishing turning tool. The polishing turning tool has, for example, a rod shape, and includes a magnetic field generating part (for example, a permanent magnet, electromagnet) for generating a magnetic field at a tip thereof and a rotation driving part for rotating the magnetic field generating part. The polishing composition of the present embodiment is attached to the tip of the polishing turning tool, and a magnetic field is generated in the magnetic field generating part to form a magnetic cluster in the polishing composition. Then, the polishing composition attached to the tip of the polishing turning tool is brought into contact with an object to be polished. In a case where the tip of the polishing tool and the object to be polished move relative to each other while rotating the magnetic field generating part by the rotation driving part, it is possible to polish the object to be polished with a sliding contact between the magnetic cluster and the object to be polished.

Furthermore, since the polishing composition of the present embodiment contains an antioxidant for suppressing oxidation of the magnetic particles, oxidation of the magnetic particles due to water, oxygen, an oxidant, and the like hardly occurs. Therefore, since a saturated magnetization of the magnetic particles is kept high, a polishing performance of the polishing composition during magnetic polishing is hardly decreased over time. This mechanism is based on speculation, and the present invention is not limited to the above mechanism at all.

In addition, since the oxidation of magnetic particles hardly occurs in the polishing composition of the present embodiment, it is also possible to store the polishing composition for a long period of time. Furthermore, since generation of hydrogen due to the oxidation of magnetic particles hardly occurs, the polishing composition of the present embodiment is highly safe.

Furthermore, in a case where a magnetic field is not applied, aggregation of the magnetic particles is suppressed due to an action of the antioxidant. Thus, in the polishing composition of the present embodiment, aggregation of the magnetic particles hardly occurs, and even in a case of being aggregated, an excellent redispersibility is exhibited.

Hereinafter, the polishing composition, the magnetic polishing method, and the like of the present embodiment will be described in more detail.

1. Regarding Object to be Polished

A material of an object to be polished is not particularly limited, and examples thereof include metals, alloys, oxides, and resins. Specific examples of the metal include iron, copper, aluminum, titanium, zirconium, ruthenium, and tungsten. Specific examples of the alloy include an aluminum alloy, an iron alloy (such as stainless steel), a magnesium alloy, a titanium alloy, a copper alloy, a chromium alloy, and a cobalt alloy. Specific examples of the metal oxide include aluminum oxide, zirconium oxide, silicon oxide, magnesium oxide, titanium oxide, gallium oxide, yttrium oxide, and germanium oxide. A form of the metal oxide is not limited and may be not only a ceramic material, a crystalline material (sapphire, quartz, or the like), and a glass, but also one generated by oxidation of the metal or the alloy. Specific examples of the resin include super engineering plastics such as polyphenyl sulfone resin (PPSU), polyphenylene sulfide resin (PPS), polyether ether ketone resin (PEEK), and polyamide imide resin (PAI). Among these, the alloy and the metal oxide are particularly preferable. In addition, the object to be polished may be an object to be polished which contains a plurality of these materials, or, for example, may be an object to be polished in which a metal oxide is formed by oxidation of a part (for example, a surface) of a metal or an alloy.

2. Regarding Magnetic Particles

Examples of magnetic particles include particles composed of a hard magnetic material or a soft magnetic material. As the particles composed of a soft magnetic material, ferromagnetic particles and paramagnetic particles are mentioned. A material of the magnetic particles is not particularly limited, and examples thereof include iron, nickel, cobalt, and oxidesthereof (for example, an iron oxide such as magnetite), nitrides thereof, and alloys thereof. In addition, it is also possible to use magnetic particles containing rare earth metals such as samarium, neodymium, and cerium. Among these, iron, nickel, cobalt, and oxides thereof, and alloys thereof are preferable from the viewpoint of a relatively large magnetism and easy handleability.

For the magnetic particles, one type thereof may be used alone, or two or more types thereof may be used in combination. In addition, in the present invention, magnetism means being sensitive to a magnetic system, for example, means a property of being attracted to a magnet.

An average primary particle diameter of the magnetic particles is preferably 200 μm or less, and more preferably 150 μm or less. In a case where the average primary particle diameter is 200 μm or less, dispersibility of the magnetic particles in the polishing composition is excellent. In addition, the average primary particle diameter of the magnetic particles is preferably 0.01 μm or more, and more preferably 1 μm or more. In a case where the average primary particle diameter is 0.01 μm or more, it is possible to have a sufficient magnetism.

Further, in particular, in a case of a final polishing in which emphasis is placed on a surface quality, the average primary particle diameter of the magnetic particles is preferably 15 μm or less, more preferably 10 μm or less, and even more preferably 5 μm or less. In a case where the average primary particle diameter of the magnetic particles is within such a range, it is possible to obtain a smooth surface while suppressing scratches of the object to be polished. In addition, in a case of a rough final polishing or a rough/intermediate final polishing in which emphasis is placed on a processing efficiency, the average primary particle diameter of the magnetic particles is preferably 10 μm or more, more preferably 20 μm or more, and even more preferably 50 μm or more. In a case where the average primary particle diameter of the magnetic particles is within such a range, it is possible to carry out polishing with a very high efficiency. It is possible to calculate the average primary particle diameter of the magnetic particles, for example, based on a specific surface area of the magnetic particles which is measured by the BET method. In addition, it is possible to carry out measurement with a dynamic light scattering method.

In a case where polishing is carried out in a plurality of stages such as first carrying out an intermediate final polishing in which emphasis is placed on a processing efficiency and then a final polishing in which emphasis is placed on a surface quality, magnetic particles with a different average primary particle diameter may be used for each stage.

A content of the magnetic particles in the polishing composition of the present embodiment is preferably 80% by mass or less, and more preferably 60% by mass or less. In a case where the content of the magnetic particles is 80% by mass or less, effects of ensuring stability and flowability of the polishing composition, and thus of maintaining a polishing accuracy are exerted. In addition, the content of the magnetic particles in the polishing composition of the present embodiment is preferably 10% by mass or more, and more preferably 20% by mass or more. In a case where the content of the magnetic particles is 10% by mass or more, effects of improving a polishing removal rate and a surface quality are exerted.

3. Regarding Antioxidant

An antioxidant is also added to a general polishing composition. However, in a case of the general polishing composition, the antioxidant is added for the purpose of suppressing oxidation of an object to be polished. On the contrary, in the present invention, the antioxidant is added for the purpose of suppressing oxidation of the magnetic particles. Therefore, types of the antioxidizing effective for suppressing oxidation are different between the polishing composition according to the present invention and the general polishing composition, and the antioxidant for suppressing oxidation of a metallic object to be polished may not be suitable for the polishing composition according to the present invention.

Due to oxidation, the magnetic particles may dissolve, or generate gases or the like. Therefore, oxidation or dissolution of the magnetic particles, generation of gas, or the like makes it possible to recognize a degree of effects of the antioxidant added to the polishing composition. In the present invention, the antioxidant is capable of adsorbing on or reacting with surfaces of the magnetic particles to suppress oxidation or dissolution of the magnetic particles, generation of gas, or the like.

A type of the antioxidant is not particularly limited as long as the antioxidant is capable of suppressing oxidation of the magnetic particles, and examples thereof include an alkenyl succinic acid derivative, a bipyridine derivative, a phenanthroline derivative, a triazole derivative, a benzotriazole derivative, and an amine having no carbon-carbon multiple bond in a molecule.

The alkenyl succinic acid derivative may include a compound represented by Formula (1), (2), or (3).

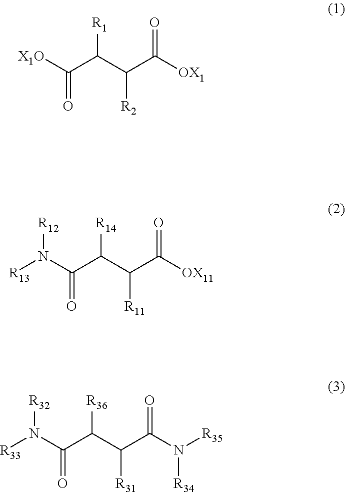

R₁ and R₂ in the compound represented by Formula (1) each independently represent a hydrogen atom or a linear or branched alkenyl group having 20 or fewer carbon atoms, where R₁ and R₂ do not become hydrogen atoms at the same time. In a case where the number of carbon atoms of the alkenyl group exceeds 20, solubility of the antioxidant in water tends to decrease. In a case where the number of carbon atoms is less than 4, a production cost for the antioxidant is increased and it becomes difficult to achieve an economical production. Thus, a lower limit of the number of carbon atoms in R₁ and R₂ is preferably 4. As specifically preferred alkenyl groups, a pentenyl group, a hexenyl group, a heptenyl group, an octenyl group, a nonenyl group, a decenyl group, an undecenyl group, a dodecenyl group, a tridecenyl group, a tetradecenyl group, a pentadecenyl group, a hexadecenyl group, a heptadecenyl group, an octadecenyl group, a nonadecenyl group, an icosenyl group, a tert-hexenyl group, a 2-ethylhexenyl group, a 2,4,6-trimethylheptenyl group, a 2,4,6,8-tetramethyl nonenyl group, and the like are mentioned.

X₁ in the compound represented by Formula (1) each independently represents a hydrogen atom or a cation (for example, a metal ion such as a sodium ion and a potassium ion, or an amine cation such as an ammonium ion, a monoethanol ammonium ion, and a quaternary ammonium ion). In a case where X₁ is an ion (cation), a COO group to which X₁ is bonded is also an ion (anion).

R₁₁ and R₁₄ in the compound represented by Formula (2) each independently represent a hydrogen atom or a linear or branched alkenyl group having 20 or fewer carbon atoms, where R₁₁ and R₁₄ do not become hydrogen atoms at the same time. In a case where the number of carbon atoms of the alkenyl group exceeds 20, solubility of the antioxidant in water tends to decrease. In a case where the number of carbon atoms is less than 4, a production cost for the antioxidant is increased and it becomes difficult to achieve an economical production. Thus, a lower limit of the number of carbon atoms in R₁₁ and R₁₄ is preferably 4. Specifically preferred alkenyl groups are the same as those for R₁ and R₂ in the compound represented by Formula (1).

R₁₂ and R₁₃ each independently represent a hydrogen atom, an alkyl group having 10 or fewer carbon atoms, an alkenyl group having 10 or fewer carbon atoms, a hydroxyalkyl group, a hydroxyalkenyl group, a polyoxyethylene group (—(CH₂CH₂O)ₙ—CH₂CH₂OH), or a polyoxypropylene group (—(CH₂CHCH₃O)ₘ—CH₂CHCH₃OH). n in the above polyoxyethylene group represents an average addition molar number of an oxyethylene group which is 1 to 19. m in the above polyoxypropylene group represents an average addition molar number of an oxypropylene group which is 1 to 19.

However, in order to impart water solubility and dispersibility to the compound represented by Formula (2), at least one of R₁₂ and R₁₃ is preferably a hydroxyalkyl group, a hydroxyalkenyl group, a polyoxyethylene group (—(CH₂CH₂O)ₙ—CH₂CH₂OH), or a polyoxypropylene group (—(CH₂CHCH₃O)ₘ—CH₂CHCH₃OH).

It is more preferable that any one of R₁₂ and R₁₃ is a hydroxyalkyl group or hydroxyalkenyl group, and it is even more preferable that any one of R₁₂ and R₁₃ is a hydroxyalkyl group having 5 or fewer carbon atoms. From the viewpoint of easy availability of a raw material, a hydroxyalkyl group having 2 or 3 carbon atoms is optimal. The hydroxyalkyl group may be either linear or branched. The number of hydroxyl groups possessed by the hydroxyalkyl group or hydroxyalkenyl group may be one, or two or more.

X₁₁ in the compound represented by Formula (2) represents a hydrogen atom or a cation (for example, a metal ion such as a sodium ion and a potassium ion, or an amine cation such as an ammonium ion, a monoethanol ammonium ion, and a quaternary ammonium ion). In a case where X₁₁ is an ion (cation), a COO group to which X₁₁ is bonded is also an ion (anion).

R₃₁ and R₃₆ in the compound represented by Formula (3) each independently represent a hydrogen atom or a linear or branched alkenyl group having 20 or fewer carbon atoms, where R₃₁ and R₃₆ do not become hydrogen atoms at the same time. In a case where the number of carbon atoms of the alkenyl group exceeds 20, solubility of the antioxidant in water tends to decrease. In a case where the number of carbon atoms is less than 4, a production cost for the antioxidant is increased and it becomes difficult to achieve an economical production. Thus, a lower limit of the number of carbon atoms in R₃₁ and R₃₆ is preferably 4. Specifically preferred alkenyl groups are the same as those for R₁ and R₂ in the compound represented by Formula (1).

R₃₂, R₃₃, R₃₄, and R₃₅ each independently represent a hydrogen atom, an alkyl group having 10 or fewer carbon atoms, an alkenyl group having 10 or fewer carbon atoms, a hydroxyalkyl group, a hydroxyalkenyl group, a polyoxyethylene group (—(CH₂CH₂O)ᵣ—CH₂CH₂OH), or a polyoxypropylene group (—(CH₂CHCH₃O)ₛ—CH₂CHCH₃OH). r in the polyoxyethylene group represents an average addition molar number of an oxyethylene group which is 1 to 19. s in the above polyoxypropylene group represents an average addition molar number of an oxypropylene group which is 1 to 19.

However, in order to impart water solubility and dispersibility to the compound represented by Formula (3), at least one of R₃₂, R₃₃, R₃₄, and R₃₅ is preferably a hydroxyalkyl group, a hydroxyalkenyl group, a polyoxyethylene group (—(CH₂CH₂O)ᵣ—CH₂CH₂OH), or a polyoxypropylene group (—(CH₂CHCH₃O)ₛ—CH₂CHCH₃OH).

It is more preferable that any one of R₃₂, R₃₃, R₃₄, and R₃₅ is a hydroxyalkyl group or hydroxyalkenyl group, and it is even more preferable that any one of R₃₂, R₃₃, R₃₄, and R₃₅ is a hydroxyalkyl group having 5 or fewer carbon atoms. From the viewpoint of easy availability of a raw material, a hydroxyalkyl group having 2 or 3 carbon atoms is optimal. The hydroxyalkyl group may be either linear or branched. The number of hydroxyl groups possessed by the hydroxyalkyl group or hydroxyalkenyl group may be one, or two or more.

Specific examples of the alkenyl succinic acid derivative represented by Formula (1) include pentenyl succinic acid, hexenyl succinic acid, heptenyl succinic acid, octenyl succinic acid, nonenyl succinic acid, decenyl succinic acid, undecenyl succinic acid, dodecenyl succinic acid, tridecenyl succinic acid, tetradecenyl succinic acid, pentadecenyl succinic acid, hexadecenyl succinic acid, heptadecenyl succinic acid, octadecenyl succinic acid, nonadecenyl succinic acid, icosenyl succinic acid, tert-hexenyl succinic acid, 2-ethylhexenyl succinic acid, 2,4,6-trimethylheptenyl succinic acid, 2,4,6,8-tetramethylnonenyl succinic acid, or salts thereof.

Specific examples of the alkenyl succinic acid derivative represented by Formula (2) include N,N-bis(2-hydroxyethyl)pentenyl succinamic acid, N,N-bis(2-hydroxyethyl)hexenyl succinamic acid, N,N-bis(2-hydroxyethyl)heptenyl succinamic acid, N,N-bis(2-hydroxyethyl)octenyl succinamic acid, N,N-bis(2-hydroxyethyl)nonenyl succinamic acid, N,N-bis(2-hydroxyethyl)decenyl succinamic acid, N,N-bis(2-hydroxyethyl)undecenyl succinamic acid, N,N-bis(2-hydroxyethyl)dodecenyl succinamic acid, N,N-bis(2-hydroxyethyl)tridecenyl succinamic acid, N,N-bis(2-hydroxyethyl)tetradecenyl succinamic acid, N,N-bis(2-hydroxyethyl)pentadecenyl succinamic acid, N,N-bis(2-hydroxyethyl)hexadecenyl succinamic acid, N,N-bis(2-hydroxyethyl)heptadecenyl succinamic acid, N,N-bis(2-hydroxyethyl)octadecenyl succinamic acid, N,N-bis(2-hydroxyethyl)nonadecenyl succinamic acid, N,N-bis(2-hydroxyethyl)icosenyl succinamic acid, N,N-bis(3-hydroxypropyl)pentenyl succinamic acid, N,N-bis(2-hydroxypropyl)octenyl succinamic acid, N,N-bis(3-hydroxypropyl)octenyl succinamic acid, N,N-bis(3-hydroxypropyl)dodecenyl succinamic acid, N,N-bis(3-hydroxypropyl)pentadecenyl succinamic acid, N-(2-hydroxyethyl)pentenyl succinamic acid, N-(2-hydroxyethyl)octenyl succinamic acid, N-(2-hydroxyethyl)dodecenyl succinamic acid, N-(2-hydroxyethyl)pentadecenyl succinamic acid, N-(3-hydroxypropyl)pentenyl succinamic acid, N-(2-hydroxypropyl)octenyl succinamic acid, N-(3-hydroxypropyl)octenyl succinamic acid, N-(3-hydroxypropyl)dodecenyl succinamic acid, N-(3-hydroxypropyl)pentadecenyl succinamic acid, N,N-bis(polyoxyethylene)octenyl succinamic acid, N,N-bis(polyoxypropylene)octenyl succinamic acid, N,N-bis(polyoxyethylene)dodecenyl succinamic acid, N,N-bis(polyoxypropylene)dodecenyl succinamic acid, N,N-bis(methyl)octenyl succinamic acid, N,N-bis(ethyl)octenyl succinamic acid, and N-(ethyl)octenyl succinamic acid.

Specific examples of the alkenyl succinic acid derivative represented by Formula (3) include N,N-bis(2-hydroxyethyl)pentenyl succinamide, N,N-bis(2-hydroxyethyl)hexenyl succinamide, N,N-bis(2-hydroxyethyl)heptenyl succinamide, N,N-bis(2-hydroxyethyl)octenyl succinamide, N,N-bis(2-hydroxyethyl)nonenyl succinamide, N,N-bis(2-hydroxyethyl)decenyl succinamide, N,N-bis(2-hydroxyethyl)undecenyl succinamide, N,N-bis(2-hydroxyethyl)dodecenyl succinamide, N,N-bis(2-hydroxyethyl)tridecenyl succinamide, N,N-bis(2-hydroxyethyl)tetradecenyl succinamide, N,N-bis(2-hydroxyethyl)pentadecenyl succinamide, N,N-bis(2-hydroxyethyl)hexadecenyl succinamide, N,N-bis(2-hydroxyethyl)heptadecenyl succinamide, N,N-bis(2-hydroxyethyl)octadecenyl succinamide, N,N-bis(2-hydroxyethyl)nonadecenyl succinamide, N,N-bis(2-hydroxyethyl)icosenyl succinamide, N,N-bis(3-hydroxypropyl)pentenyl succinamide, N,N-bis(2-hydroxypropyl)octenyl succinamide, N,N-bis(3-hydroxypropyl)octenyl succinamide, N,N-bis(3-hydroxypropyl)dodecenyl succinamide, N,N-bis(3-hydroxypropyl)pentadecenyl succinamide, N-(2-hydroxyethyl)pentenyl succinamide, N-(2-hydroxyethyl)octenyl succinamide, N-(2-hydroxyethyl)dodecenyl succinamide, N-(2-hydroxyethyl)pentadecenyl succinamide, N-(3-hydroxypropyl)pentenyl succinamide, N-(2-hydroxypropyl)octenyl succinamide, N-(3-hydroxypropyl)octenyl succinamide, N-(3-hydroxypropyl)dodecenyl succinamide, N-(3-hydroxypropyl)pentadecenyl succinamide, N,N-bis(polyoxyethylene)octenyl succinamide, N,N-bis(polyoxypropylene)octenyl succinamide, N,N-bis(polyoxyethylene)dodecenyl succinamide, N,N-bis(polyoxypropylene)dodecenyl succinamide, N,N, N′-tris(2-hydroxyethyl)octenyl succinamide, N,N,N′,N′-tetrakis(2-hydroxyethyl)octenyl succinamide, N,N,N′,N′-tetrakis(2-hydroxypropyl)octenyl succinamide, N,N,N′,N′-tetrakis(3-hydroxypropyl)octenyl succinamide.

In order to improve solubility and dispersibility of the alkenyl succinic acid derivative with respect to water, X₁, X₁₁, or X₂₁ in the compound represented by Formula (1) or (2) may be a cation (for example, a metal ion such as sodium ion and potassium ion, or an amine cation such as an ammonium ion, a monoethanolammonium ion, and a quaternary ammonium ion). In that case, a compound in which X₁, X₁₁, or X₂₁ is a hydrogen atom is blended in the polishing composition, and a basic substance which undergoes a neutralization reaction with a carboxyl group is added thereto so as to cause a reaction, whereby X₁, X₁₁, or X₂₁ may be converted into a metal ion or a cation.

Examples of the basic substance include a hydroxide of an alkali metal such as sodium hydroxide and potassium hydroxide. In addition, amines such as monoethanolamine, diethanolamine, triethanolamine, ethylenediamine, diethylenetriamine, triethylenetetramine, methylamine, dimethylamine, trimethylamine, ethylamine, diethylamine, triethylamine, n-butylamine, n-dibutylamine, n-tributylamine, tert-butylamine, ethylenediamine, N-ethylethylenediamine, diethylenetriamine, triethylenetetramine, 1,2-diaminopropane, tetramethylammonium hydroxide, cyclohexylamine, N,N,N′,N′-tetramethylethylenediamine, pyrrolidine, piperidine, piperazine, pyridine, pyrazine, 1,2-cyclohexanediamine, 1,4-cyclohexanediamine, monoisopropanolamine, diisopropanolamine, triisopropanolamine, N,N-bis(2-hydroxyethyl)-N-cyclohexylamine, N,N,N′,N′-tetrakis(2-hydroxyethyl)ethylenediamine, N,N,N′,N′-tetrakis(2-hydroxyethyl)-1,6-hexamethylenediamine, dicyclohexylamine, cyclohexyldiethanolamine, morpholine, 2-amino-2-methyl-1-propanol, monoethanol diisopropanolamine, N,N-dimethylethanolamine, and N,N-diethylethanolamine are mentioned.

The bipyridine derivative may include a compound represented by Formula (4).

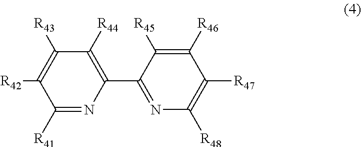

R₄₁, R₄₂, R₄₃, R₄₄, R₄₅, R₄₆, R₄₇, and R₄₈ in the compound represented by Formula (4) each independently represent a hydrogen atom, an alkyl group, an alkenyl group, a phenyl group, a hydroxyl group, an amino group, a carboxyl group, a sulfo group, a nitro group, a halogen group, a hydroxyalkyl group, a hydroxyalkenyl group, an alkylamino group, an alkenylamino group, a carboxylalkyl group, a carboxylalkenyl group, an alkylsulfo group, an alkenylsulfo group, an alkylnitro group, an alkenylnitro group, an alkoxy group, an acetyl group, an alkyl ether group, an alkenyl ether group, an alkyl halogen group, and an alkenyl halogen group.

Specific examples of the bipyridine derivative include 2,2′-bipyridine derivatives such as 2,2′-bipyridine, 4,4′-dimethanol-2,2′-bipyridine, 5,5′-dicarboxylic acid-2,2′-bipyridine, 3-hydroxy-4,4′-dimethyl-2,2′-bipyridine, 6-methoxy-2,2′-bipyridine, 3,3′-dihydroxy-2,2′-bipyridine, 6,6′-dihydroxy-2,2′-bipyridine, 3-carboxy-2,2′-bipyridine, 4-carboxy-2,2′-bipyridine, 6-carboxy-2,2′-bipyridine, 6-bromo-2,2′-bipyridine, 6-chloro-2,2′-bipyridine, 6,6′-diamino-2,2′-bipyridine, 6,6′-dimethyl-2,2′-bipyridine, and 6,6′-disulfone-2,2′-bipyridine, and salts thereof.

The phenanthroline derivative may include a compound represented by Formula (5).

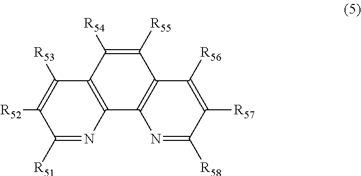

R₅₁, R₅₂, R₅₃, R₅₄, R₅₅, R₅₆, R₅₇, and R₅₈ in the compound represented by Formula (5) each independently represent a hydrogen atom, an alkyl group, an alkenyl group, a phenyl group, a hydroxyl group, an amino group, a carboxyl group, a sulfo group, a nitro group, a halogen group, a hydroxyalkyl group, a hydroxyalkenyl group, an alkylamino group, an alkenylamino group, a carboxylalkyl group, a carboxylalkenyl group, an alkylsulfo group, an alkenylsulfo group, an alkylnitro group, an alkenylnitro group, an alkoxy group, an acetyl group, an alkyl ether group, an alkenyl ether group, an alkyl halogen group, and an alkenyl halogen group.

Specific examples of the phenanthroline derivative include 1,10-phenanthroline, 2-chloro-1,10-phenanthroline, 5-chloro-1,10-phenanthroline, 2-bromo-1,10-phenanthroline, 3-bromo-1,10-phenanthroline, 5-bromo-1,10-phenanthroline, 3,8-dibromo-1,10-phenanthroline, 2,9-dimethyl-1,10-phenanthroline, 2,9-dimethyl-4,7-diphenyl-1,10-phenanthroline, 3,4,7,8-tetramethyl-1,10-phenanthroline, 5-amino-1,10-phenanthroline, 4,7-dihydroxy-1,10-phenanthroline, 3,4,7,8-tetrahydroxy-1,10-phenanthroline, 1,10-phenanthroline-2,9-dicarboxylic acid, 5-nitro-1,10-phenanthroline-2,9-dicarboxylic acid, 1,10-phenanthroline-2,9-disulfonic acid, 4,7-diphenyl-1,10-phenanthroline-2,9-disulfonic acid, 1,10-phenanthroline-5,6-dione, and salts thereof, and hydrates thereof.

As the triazole derivative, a compound having a triazole structure and a salt thereof are mentioned. Specific examples thereof include 1,2,3-triazole, 1,2,4-triazole, 1-methyl-1,2,4-triazole, 3-nitro-1,2,4-triazole, 1H-1,2,4-triazole-3-thiol, 4-(1,2,4-triazole-1-yl)phenol, methyl-1H-1,2,4-triazole-3-carboxylate, 1,2,4-triazole-3-carboxylic acid, methyl 1,2,4-triazole-3-carboxylate, 3-amino-1H-1,2,4-triazole, 3-amino-5-benzle-4H-1,2,4-triazole, 3-amino-5-methyl-4H-1,2,4-triazole, 3-amino-1,2,4-triazole-5-thiol, 3,5-diamino-1H-1,2,4-triazole, 3-bromo-5-nitro-1,2,4-triazole, 4-amino-1,2,4-triazole, 4-amino-3,5-dipropyl-4H-1,2,4-triazole, 4-amino-3,5-dimethyl-4H-1,2,4-triazole, 4-amino-3,5-dipeptyl-4H-1,2,4-triazole, and 5-methyl-1,2,4-triazole-3,4-diamine.

As the benzotriazole derivative, a compound having a benzotriazole structure and a salt thereof are mentioned. Specific examples thereof include benzotriazole, 2,2′-[[(methyl-1H-benzotriazol-1-yl)methyl]imino]bisethanol, 5-chlorobenzotriazole, 1H-benzotriazole-1-methanol, 5-methyl-1H-benzotriazole, 5-nitrobenzotriazole, 5-carboxybenzotriazole, 5-aminobenzotriazole, 5,6-dimethyl-1H-benzotriazole, 1-(1″,2′-dicarboxyethyl)benzotriazole, 1-[N,N-bis(hydroxyethyl)aminomethyl]benzotriazole, 1-[N,N-bis(hydroxyethyl)aminomethyl]-5-methylbenzotriazole, and 1-[N,N-bis(hydroxyethyl)aminomethyl]-4-methylbenzotriazole.

Examples of the amine having no carbon-carbon multiple bond in a molecule may include compounds represented by Formulas (6), (7), (8), and (9).

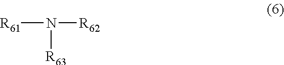

R₆₁, R₆₂, and R₅₃ in the compound represented by Formula (6) are each independently a hydrogen atom, an alkyl group, or a hydroxyalkyl group, or are each independently a carboxyalkyl group, a phosphoalkyl group, or a sulfoalkyl group. R₆₁, R₆₂, and R₆₃ may be bonded to one another among carbon atoms to form a cyclic structure (cyclic alkane), where three of R₆₁, R₆₂, and R₆₃ do not become hydrogen atoms at the same time. A carbon chain possessed by R₆₁, R₆₂, and R₆₃ may be linear or branched. In a case where at least one of R₆₁, R₆₂, and R₆₃ is a hydroxyalkyl group, an antioxidizing effect of the magnetic particles is increased, which is preferable. The number of hydroxyl groups possessed by the hydroxyalkyl group may be one, or two or more.

Specific examples of the compound represented by Formula (6) include methylamine, dimethylamine, trimethylamine, ethylamine, diethylamine, triethylamine, n-butylamine, tert-butylamine, dibutylamine, tributylamine, monoethanolamine, diethanolamine, triethanolamine, monopropanolamine, 3-methylamino-1,2-propanediol, diisopropanolamine, nitrilotrimethylene phosphonic acid, nitrilotriacetic acid, 3,3′,3″-nitrilotripropionic acid, pyrrolidine, 1-methylpyrrolidine, 2-methylpyrrolidine, 1-ethylpyrrolidine, 2-ethylpyrrolidine, 1-(2-hydroxyethyl)pyrrolidine, 2-(hydroxymethyl)pyrrolidine, 2-(2-hydroxyethyl)-1-methylpyrrolidine, piperidine, 3,5-dimethylpiperidine, 2-methylpiperidine, 4-methylpiperidine, 1-piperidineethanol, 1-ethanol-4-propanolpiperidine, 3-quinuclidinol, cyclohexylamine, N,N-bis(2-hydroxyethyl)isopropanolamine, and N,N-dimethylethanolamine.

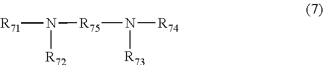

R₇₁, R₇₂, R₇₃, and R₇₄ in the compound represented by Formula (7) each independently represent a hydrogen atom, an alkyl group, or a hydroxyalkyl group. R₇₁, R₇₂, R₇₃, and R₇₄ may be bonded to one another among carbon atoms to form a cyclic structure (cyclic alkane). R₇₅ in the compound represented by Formula (7) represents an alkylene group having 2 to 10 carbon atoms. A carbon chain possessed by R₇₁, R₇₂, R₇₃, R₇₄, and R₇₅ may be any of linear, branched, and cyclic. In a case where at least one of R₇₁, R₇₂, R₇₃, and R₇₄ is a hydroxyalkyl group, an antioxidizing effect of the magnetic particles is increased, which is preferable.

The number of hydroxyl groups possessed by the hydroxyalkyl group may be one, or two or more.

Specific examples of the compound represented by Formula (7) include ethylenediamine, N-methylethylenediamine, N-ethylethylenediamine, N,N-dimethylethylenediamine, N, N-diethylethylenediamine, N,N′-diethylethylenediamine, N,N,N′,N′-tetramethylethylenediamine, 1,2-diaminopropane, 2-methyl-1,2-propanediamine, N-(2-hydroxyethyl)ethylenediamine, N,N′-bis(2-hydroxyethyl)ehtylenediamine, N-(2-hydroxypropyl)ethylenediamine, N,N,N′,N′-tetrakis(2-hydroxyethyl)ethylenediamine, 1,3-diaminopropane, 2,2-dimethyl-1,3-propanediamine, 2-methyl-1,3-propanediamine, N-methyl-1,3-propanediamine, N,N-dimethyl-1,3-propane diamine, N,N-diethyl-1,3-propanediamine, N,N-bis(2-hydroxyethyl)-1,3-diaminopropane, piperazine, 1-methylpiperazine, 1-ethylpiperazine, N,N′-dimethylpiperazine, 1-(2-hydroxyethyl)piperazine, 4-methylpiperazine-1-ethanol, 1,4-bis(2-hydroxyethyl)piperazine, 1,2-cyclohexanediamine, and 1,4-cyclohexanediamine.

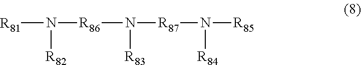

R₈₁, R₈₂, R₈₃, R₈₄, and R₈₅ in the compound represented by Formula (8) each independently represent a hydrogen atom, an alkyl group, or a hydroxyalkyl group. R₈₁, R₈₂, R₈₃, R₈₄, and R₈₅ may be bonded to one another among carbon atoms to form a cyclic structure (cyclic alkane). R₈₆ and R₈₇ in the compound represented by Formula (8) represent alkylene groups having 2 to 10 carbon atoms. A carbon chain possessed by R₈₁, R₈₂, R₈₃, R₈₄, R₈₅, R₈₆, and R₈₇ may be any of linear, branched or cyclic. In a case where at least one of R₈₁, R₈₂, R₈₃, R₈₄, and R₈₅ is a hydroxyalkyl group, an antioxidizing effect of the magnetic particles is increased, which is preferable. The number of hydroxyl groups possessed by the hydroxyalkyl group may be one, or two or more.

Specific examples of the compound represented by Formula (8) include diethylenetriamine, N,N,N′,N″,N″-pentamethyldiethylenetriamine, N,N,N′,N″,N″-pentakis(2-hydroxypropyl)diethylenetriamine, 3,3′-diaminodipropylamine, N-(3-aminopropyl)-N-methyl-1,3-propandiamine, N′-[3-(dimethylamino)propyl]-N,N-dimethyl-1,3-propanediamine, 2,6,10-trimethyl-2,6,10-triazaundecane, N-(2-aminoethyl)piperazine, 1,4,7-triazacyclononane, and N,N,N′,N″,N″-pentakis(2-hydroxypropyl)diethylenetriamine.

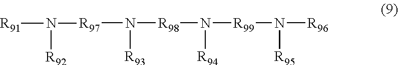

R₉₁, R₉₂, R₉₃, R₉₄, R₉₅, and R₉₆ in the compound represented by Formula (9) each independently represent a hydrogen atom, an alkyl group, or a hydroxyalkyl group. R₉₁, R₉₂, R₉₃, R₉₄, R₉₅, and R₉₆ may be bonded to one another among carbon atoms to form a cyclic structure (cyclic alkane). R₉₇, R₉₈, and R₉₉ in the compound represented by Formula (9) represent alkylene groups having 2 to 10 carbon atoms. A carbon chain possessed by R₉₁, R₉₂, R₉₃, R₉₄, R₉₅, R₉₆, R₉₇, R₉₈, and R₉₉ may be any of linear, branched, and cyclic. In a case where at least one of R₉₁, R₉₂, R₉₃, R₉₄, R₉₅, and R₉₅ is a hydroxyalkyl group, an antioxidizing effect of the magnetic particles is increased, which is preferable. The number of hydroxyl groups possessed by the hydroxyalkyl group may be one, or two or more.

Specific examples of the compound represented by Formula (9) include triethylenetetramine, N,N,N′,N″,N′″, N′″-hexamethyltriethylenetetramine, 1,4-bis(3-aminopropyl)piperazine, and 1,4,7,10-tetraazacyclododecane.

The alkenyl succinic acid derivative, the bipyridine derivative, the phenanthroline derivative, the triazole derivative, and the benzotriazole derivative also include alkenyl succinic acid, 2,2′-bipyridine, 1,10-phenanthroline, triazole, and benzotriazole. For the antioxidant, one type thereof may be used alone, or two or more types thereof may be used in combination.

A content of the antioxidant in the polishing composition of the present embodiment is preferably 5% by mass or less, and more preferably 1% by mass or less. In a case where the content of the antioxidant is 5% by mass or less, effects of maintaining a polishing removal rate while providing protection for a surface of the object to be polished are exerted. In addition, the content of the antioxidant in the polishing composition of the present embodiment is preferably 0.01% by mass or more, and more preferably 0.1% by mass or more. In a case where the content of the antioxidant is 0.01% by mass or more, an effect of preventing oxidation of the magnetic particles is excellent.

4. Regarding Water

The polishing composition of the present embodiment contains a liquid medium as a dispersion medium or a solvent for dispersing or dissolving the respective components such as magnetic particles and an antioxidant. A type of the liquid medium is not particularly limited, and water, an organic solvent, and the like are mentioned. However, from the viewpoint of explosion-proof measures and reduction of environmental loads, it is preferable to contain water. From the viewpoint that inhibition of an action of each of the other components is suppressed, water which does not contain impurities as much as possible is preferable. Specifically, pure water, ultrapure water, or distilled water obtained by removing impurity ions with an ion exchange resin, and then removing foreign matters through a filter is preferable.

5. Regarding Nonmagnetic Abrasive Particles

The polishing composition of the present embodiment may further contain non-magnetic abrasive particles. In a case where the polishing composition contains nonmagnetic abrasive particles, and a magnetic field is applied to the polishing composition to form a magnetic cluster, the abrasive particles form the magnetic cluster together with the magnetic particles. Thus, a polishing performance and a polishing removal rate of the polishing composition of the present embodiment are improved, and a surface quality of a surface to be polished of an object to be polished becomes better.

A type of the abrasive particles is not particularly limited, and examples thereof include inorganic particles, organic particles, and organic-inorganic composite particles. Specific examples of the inorganic particles include particles formed of a metal oxide such as silica, alumina, ceria, and titania, silicon nitride particles, silicon carbide particles, and boron nitride particles. Specific examples of the organic particles include polymethyl methacrylate (PMMA) particles. For the abrasive particles, one type thereof may be used alone, or two or more types thereof may be used in combination. In addition, commercially available products may be used, or synthetic products may be used. Among the above abrasive particles, silica and alumina are more preferable.

Furthermore, the abrasive particles may be those that are surface-modified. It is possible to obtain the surface-modified abrasive particles, for example, by mixing a metal such as aluminum, titanium, and zirconium, or an oxide thereof with abrasives and doping the metal such as aluminum, titanium, and zirconium, or the oxide thereof on surfaces of abrasives, or immobilizing an organic acid on the surfaces of abrasives. Among the surface-modified abrasive particles, colloidal silica on which an organic acid is immobilized is particularly preferable.

It is possible to carry out immobilization of the organic acid on the surface of the colloidal silica, for example, by chemically bonding a functional group of the organic acid to a surface of the colloidal silica. Immobilization of the organic acid on the colloidal silica is not accomplished simply by causing the colloidal silica and the organic acid to coexist with each other. In a case where sulfonic acid which is one type of organic acids is immobilized on colloidal silica, for example, it is possible to carry out such immobilization with a method described in “Sulfonic acid-functionalized silica through quantitative oxidation of thiol groups”, Chem. Commun. 246-247 (2003). Specifically, by coupling a silane coupling agent having a thiol group such as 3-mercaptopropyltrimethoxysilane to the colloidal silica and then oxidizing the thiol group with hydrogen peroxide, it is possible to obtain colloidal silica on a surface of which sulfonic acid is immobilized.

Alternatively, in a case where carboxylic acid is immobilized on colloidal silica, for example, it is possible to carry out such immobilization with a method described in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, by coupling a silane coupling agent containing a photoreactive 2-nitrobenzyl ester to the colloidal silica and then irradiating the silane coupling agent with light, it is possible to obtain colloidal silica on a surface of which carboxylic acid is immobilized.

In addition, it is also possible to use cationic silica produced by adding a basic aluminum salt or a basic zirconium salt as disclosed in JP H4-214022 A.

An average primary particle diameter of the abrasive particles is preferably 100 μm or less, and more preferably 50 μm or less. In a case where the average primary particle diameter is 100 μm or less, it is easy to redisperse magnetic particles even in a case of being sedimented during storage of a slurry-like polishing composition. In addition, the average primary particle diameter of the abrasive particles is preferably 5 nm or more, more preferably 10 nm or more, and even more preferably 50 nm or more. In a case where the average primary particle diameter of the abrasive particles is within such a range, it is possible to efficiently polish the object to be polished.

In a case of a final polishing in which emphasis is placed on a surface quality, the average primary particle diameter of the abrasive particles is preferably 1,000 nm or less, more preferably 500 nm or less, and even more preferably 300 nm or less. In a case where the average primary particle diameter of the abrasive particles is within such a range, it is possible to further suppress occurrence of scratches on a surface of the object to be polished after polishing using the polishing composition, in addition to efficient polishing.

In addition, in a case of an intermediate final polishing in which emphasis is placed on a processing efficiency, the average primary particle diameter of the abrasive particles is preferably 1 μm or more, more preferably 5 μm or more, and even more preferably 10 μm or more. In a case where the average primary particle diameter of the abrasive particles is within such a range, it is possible to carryout polishing with a very high efficiency.

The average primary particle diameter of the abrasive particles is calculated, for example, based on a specific surface area of the abrasive particles which is measured by the BET method. In addition, it is possible to carry out measurement with a dynamic light scattering method.

In a case where the polishing is carried out in a plurality of stages such as first carrying out an intermediate final polishing in which emphasis is placed on a processing efficiency and then a final polishing in which emphasis is placed on a surface quality, abrasive particles with a different average primary particle diameter may be used for each stage.

A content of the abrasive particles in the polishing composition of the present embodiment is preferably 40% by mass or less, and more preferably 20% by mass or less. In a case where the content of the abrasive particles is 40% by mass or less, effects of ensuring stability and flowability of the polishing composition, and thus of maintaining a polishing accuracy are exerted. In addition, the content of the abrasive particles in the polishing composition of the present embodiment is preferably 1% by mass or more, and more preferably 5% by mass or more. In a case where the content of the abrasive particles is 1% by mass or more, effects of improving a polishing removal rate and a surface quality are exerted.

6. Regarding pH of Polishing Composition

A pH of the polishing composition of the present embodiment is not particularly limited. However, depending on a type of the antioxidant, the pH may be 5 or more, or may be 7 or more. In addition, it is possible to set the pH of the polishing composition of the present embodiment to be less than 14, and also to be 12 or less, depending on a type of the antioxidant. In the polishing composition having a pH in this range, aggregation of the magnetic particles hardly occurs, and it is possible to efficiently polish the object to be polished. In a case where iron powders are used as the magnetic particles, the pH of the polishing composition is more preferably 5 to 12, and even more preferably 7 to 12.

It is possible to adjust the pH of the polishing composition by adding a pH adjusting agent. The pH adjusting agent used as necessary for adjusting the pH of the polishing composition to a desired value may be either an acid or a base, and may also be either an inorganic compound or an organic compound.

Specific examples of the base as the pH adjusting agent include hydroxides of alkali metals or salts thereof, hydroxides of alkaline earth metals or salts thereof, quaternary ammonium hydroxides or salts thereof, ammonia, and amines.

Specific examples of the alkali metal include potassium and sodium. In addition, specific examples of the alkaline earth metal include calcium and strontium. Furthermore, specific examples of the salt include carbonates, hydrogen carbonates, sulfates, and acetates. Furthermore, specific examples of the quaternary ammonium include tetramethylammonium, tetraethylammonium, and tetrabutylammonium.

As the quaternary ammonium hydroxide compound, quaternary ammonium hydroxides or salts thereof are mentioned, and specific examples thereof include tetramethylammonium hydroxide, tetraethylammonium hydroxide, and tetrabutylammonium hydroxide.

Specific examples of the amine include methylamine, dimethylamine, trimethylamine, ethylamine, diethylamine, triethylamine, ethylenediamine, monoethanolamine, N-(β-aminoethyl)ethanolamine, hexamethylenediamine, diethylenetriamine, triethylenetetramine, anhydrous piperazine, piperazine hexahydrate, 1-(2-aminoethyl)piperazine, N-methylpiperazine, and guanidine.

Examples of the acid as the pH adjusting agent include inorganic acids and organic acids. Specific examples of the inorganic acid include sulfuric acid, nitric acid, boric acid, carbonic acid, hypophosphorous acid, phosphorous acid, and phosphoric acid. In addition, specific examples of the organic acid include carboxylic acids such as formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, and citric acid, and organic sulfuric acids such as methanesulfonic acid, ethanesulfonic acid, and isethionic acid. For these pH adjusting agents, one type thereof may be used alone, or two or more types thereof may be used in combination.

7. Regarding Electrical Conductivity of Polishing Composition

An electrical conductivity of the polishing composition of the present embodiment is not particularly limited, and is preferably 20 mS/cm or less, more preferably 10 mS/cm or less, and even more preferably 5 mS/cm or less. In a case where the electric conductivity is within such a range, it is less likely that oxidation of the magnetic particles occurs. Thus, it is possible to further prolong a life of the polishing composition. It is possible to control the electric conductivity with a type, addition amount, or the like of a salt compound added to the polishing composition.

8. Regarding Other Additives

In the polishing composition of the present embodiment, as necessary, other additives such as an oxidant (for example, an oxidant containing a halogen atom), a complexing agent, a metal anticorrosive agent, a surfactant, a water-soluble polymer, a preservative, and an antifungal agent may be further added. Hereinafter, such other additives will be described.

(1) Regarding Oxidant

The oxidant may be contained in the polishing composition of the present embodiment. A type of the oxidant is not particularly limited, and examples thereof include hydrogen peroxide, peracetic acid, percarbonate, urea peroxide, perchlorate, and persulfate. However, in order to suppress oxidation of the magnetic particles, a content of the oxidant in the polishing composition of the present embodiment is preferably 10% by mass or less, and more preferably 5% by mass or less. In a case where iron powders are used as the magnetic particles, it is more preferable that the polishing composition contains substantially no oxidant.

Meanwhile, “to contain substantially no oxidant” means that at least the oxidant is not intentionally contained. Therefore, a polishing composition that inevitably contains a trace amount of oxidant (for example, a molar concentration of the oxidant in the polishing composition is 0.0005 mol/L or less, preferably 0.0001 mol or less, more preferably 0.00001 mol/L or less, and particularly preferably 0.000001 mol/L or less) which is derived from raw materials or a production method is allowed to be included in a concept of a polishing composition containing substantially no oxidant which is referred to herein.

(2) Regarding Metal Anticorrosive Agent

The metal anticorrosive agent may be contained in the polishing composition of the present embodiment. In order to suppress corrosion of the object to be polished, it is possible to prevent metal dissolution by adding the metal anticorrosive agent. By using the metal anticorrosive agent, it is possible to suppress deterioration such as surface roughness of a surface of the object to be polished.

The metal anticorrosive agent that is usable is not particularly limited, and is preferably a heterocyclic compound. The number of member rings of the heterocycle in the heterocyclic compound is not particularly limited. In addition, the heterocyclic compound may be a monocyclic compound or a polycyclic compound having a condensed ring. For the metal anticorrosive agent, one type may be used alone, or two or more types may be used in combination. In addition, as the metal anticorrosive agent, commercially available products may be used, or synthetic products may be used. Furthermore, an anticorrosive agent having an antioxidizing effect for the magnetic particles may be used.

Specific examples of the heterocyclic compound usable as the metal anticorrosive agent include nitrogen-containing heterocyclic compounds such as a pyrrole compound, a pyrazole compound, an imidazole compound, a triazole compound, a tetrazole compound, a pyridine compound, a pyrazine compound, a pyridazine compound, a pyrindine compound, an indolizine compound, an indole compound, an isoindole compound, an indazole compound, a purine compound, a quinolizine compound, a quinoline compound, an isoquinoline compound, a naphthyridine compound, a phthalazine compound, a quinoxaline compound, a quinazoline compound, a cinnoline compound, a butyridine compound, a thiazole compound, an isothiazole compound, an oxazole compound, an isoxazole compound, and a furazan compound.

More specifically, examples of the pyrazole compound include 1H-pyrazole, 4-nitro-3-pyrazolecarboxylic acid, 3,5-pyrazolecarboxylic acid, 3-amino-5-phenylpyrazole, 5-amino-3-phenylpyrazole, 3,4,5-tribromopyrazole, 3-aminopyrazole, 3,5-dimethylpyrazole, 3,5-dimethyl-1-hydroxymethylpyrazole, 3-methylpyrazole, 1-methylpyrazole, 3-amino-5-methylpyrazole, 4-amino-pyrazolo[3,4-d]pyrimidine, allopurinol, 4-chloro-1H-pyrazolo[3,4-D]pyrimidine, 3,4-dihydroxy-6-methylpyrazolo(3,4-B)-pyridine, and 6-methyl-1H-pyrazolo[3,4-b]pyridine-3-amine.

Examples of the imidazole compound include imidazole, 1-methylimidazole, 2-methylimidazole, 4-methylimidazole, 1,2-dimethylpyrazole, 2-ethyl-4-methylimidazole, 2-isopropylimidazole, benzimidazole, 5,6-dimethylbenzimidazole, 2-aminobenzimidazole, 2-chlorobenzimidazole, 2-methylbenzimidazole, 2-(1-hydroxyethyl)benzimidazole, 2-hydroxybenzimidazole, 2-phenylbenzimidazole, 2,5-dimethylbenzimidazole, 5-methylbenzimidazole, 5-nitrobenzimidazole, and 1H-purine.

Examples of the triazole compound include 1,2,3-triazole, 1,2,4-triazole, 1-methyl-1,2,4-triazole, methyl-1H-1,2,4-triazole-3-carboxylate, 1,2,4-triazole-3-carboxylic acid, methyl 1,2,4-triazole-3-carboxylate, 1H-1,2,4-triazole-3-thiol, 3,5-diamino-1H-1,2,4-triazole, 3-amino-1,2,4-triazole-5-thiol, 3-amino-1H-1,2,4-triazole, 3-amino-5-benzyl-4H-1,2,4-triazole, 3-amino-5-methyl-4H-1,2,4-triazole, 3-nitro-1,2,4-triazole, 3-bromo-5-nitro-1,2,4-triazole, 4-(1,2,4-triazol-1-yl)phenol, 4-amino-1,2,4-triazole, 4-amino-3,5-dipropyl-4H-1,2,4-triazole, 4-amino-3,5-dimethyl-4H-1,2,4-triazole, 4-amino-3,5-dipeptyl-4H-1,2,4-triazole, 5-methyl-1,2,4-triazole-3,4-diamine, 1H-benzotriazole, 1-hydroxybenzotriazole, 1-aminobenzotriazole, 1-carboxybenzotriazole, 5-chloro-1H-benzotriazole, 5-nitro-1H-benzotriazole, 5-carboxy-1H-benzotriazole, 5-methyl-1H-benzotriazole, 5,6-dimethyl-1H-benzotriazole, 1-(1′,2′-dicarboxyethyl)benzotriazole, 1-[N,N-bis(hydroxyethyl)aminomethyl]benzotriazole, 1-[N,N-bis(hydroxyethyl)aminomethyl]-5-methylbenzotriazole, and 1-[N,N-bis(hydroxyethyl)aminomethyl]-4-methylbenzotriazole.

Examples of the tetrazole compound include 1H-tetrazole, 5-methyltetrazole, 5-aminotetrazole, and 5-phenyltetrazole.

Examples of the indazole compound include 1H-indazole, 5-amino-1H-indazole, 5-nitro-1H-indazole, 5-hydroxy-1H-indazole, 6-amino-1H-indazole, 6-nitro-1H-indazole, 6-hydroxy-1H-indazole, and 3-carboxy-5-methyl-1H-indazole.

Examples of the indole compound include 1H-indole, 1-methyl-1H-indole, 2-methyl-1H-indole, 3-methyl-1H-indole, 4-methyl-1H-indole, 5-methyl-1H-indole, 6-methyl-1H-indole, 7-methyl-1H-indole, 4-amino-1H-indole, 5-amino-1H-indole, 6-amino-1H-indole, 7-amino-1H-indole, 4-hydroxy-1H-indole, 5-hydroxy-1H-indole, 6-hydroxy-1H-indole, 7-hydroxy-1H-indole, 4-methoxy-1H-indole, 5-methoxy-1H-indole, 6-methoxy-1H-indole, 7-methoxy-1H-indole, 4-chloro-1H-indole, 5-chloro-1H-indole, 6-chloro-1H-indole, 7-chloro-1H-indole, 4-carboxy-1H-indole, 5-carboxy-1H-indole, 6-carboxy-1H-indole, 7-carboxy-1H-indole, 4-nitro-1H-indole, 5-nitro-1H-indole, 6-nitro-1H-indole, 7-nitro-1H-indole, 4-nitrile-1H-indole, 5-nitrile-1H-indole, 6-nitrile-1H-indole, 7-nitrile-1H-indole, 2,5-dimethyl-1H-indole, 1,2-dimethyl-1H-indole, 1,3-dimethyl-1H-indole, 2,3-dimethyl-1H-indole, 5-amino-2,3-dimethyl-1H-indole, 7-ethyl-1H-indole, 5-(aminomethyl)indole, 2-methyl-5-amino-1H-indole, 3-hydroxymethyl-1H-indole, 6-isopropyl-1H-indole, and 5-chloro-2-methyl-1H-indole.

Among these, the heterocyclic compound is preferably a triazole compound, and particularly preferably 1H-benzotriazole, 5-methyl-1H-benzotriazole, 5,6-dimethyl-1H-benzotriazole, 1-[N,N-bis(hydroxyethyl)aminomethyl]-5-methylbenzotriazole, 1-[N,N-bis(hydroxyethyl)aminomethyl]-4-methylbenzotriazole, 1,2,3-triazole, and 1,2,4-triazole.

Due to having a high chemical or physical adsorption power to a surface of the object to be polished, these heterocyclic compounds allow a stronger protective film to be formed on the surface of the object to be polished. This is advantageous in improving a flatness of the surface of the object to be polished after performing polishing using the polishing composition of the present embodiment.

A content of the metal anticorrosive agent in the polishing composition is preferably 0.0001% by mass or more, and more preferably 0.0005% by mass or more. As the content of the metal anticorrosive agent is increased, it is possible to prevent metal dissolution and to improve a level-difference eliminating property. In addition, the content of the metal anticorrosive agent in the polishing composition is preferably 1% by mass or less, more preferably 0.5% by mass or less, and even more preferably 0.1% by mass or less. As the content of the metal anticorrosive agent is decreased, a polishing removal rate is improved.

(3) Regarding Surfactant

A surfactant may be contained in the polishing composition of the present embodiment. The surfactant imparts hydrophilicity to a polished surface after polishing, so that the polished surface after polishing exhibits a good cleaning efficiency. Thus, it is possible to prevent dirt from adhering to the polished surface. A type of the surfactant is not particularly limited, and may be any of an anionic surfactant, a cationic surfactant, an amphoteric surfactant, and a nonionic surfactant. For these surfactants, one type thereof may be used alone, or two or more types thereof may be used in combination.

Examples of the anionic surfactant include polyoxyethylene alkyl ether acetic acid, polyoxyethylene alkyl sulfuric acid ester, alkyl sulfuric acid ester, polyoxyethylene alkyl ether sulfuric acid, alkyl ether sulfuric acid, alkylbenzene sulfonic acid, alkyl phosphate ester, polyoxyethylene alkyl phosphoric acid ester, polyoxyethylene sulfosuccinic acid, alkylsulfosuccinic acid, alkylnaphthalenesulfonic acid, alkyldiphenyl ether disulfonic acid, and salts thereof.

Examples of the cationic surfactant include an alkyltrimethylammonium salt, analkyldimethylammonium salt, an alkylbenzyldimethylammonium salt, and an alkylamine salt.

Examples of the amphoteric surfactant include an alkylbetaine and an alkylamine oxide.

Examples of the nonionic surfactant include a polyoxyethylene alkyl ether, a polyoxyalkylene alkyl ether, a sorbitan fatty acid ester, a glycerin fatty acid ester, a polyoxyethylene fatty acid ester, a polyoxyethylene alkyl amine, and an alkyl alkanol amide.

A content of the surfactant in the polishing composition is preferably 0.0001% by mass or more, and more preferably 0.001% by mass or more. As the content of the surfactant is increased, a cleaning efficiency of a polished surface after polishing is further improved. In addition, the content of the surfactant in the polishing composition is preferably 1% by mass or less, and more preferably 0.1% by mass or less. As the content of the surfactant is decreased, a residual amount of the surfactant on the polished surface is decreased, and a cleaning efficiency is further improved.

(4) Regarding Water-Soluble Polymer

A water-soluble polymer may be contained in the polishing composition of the present embodiment. In a case where the water-soluble polymer is added to the polishing composition, redispersibility of the magnetic particles and the abrasive particles becomes better. A type of the water-soluble polymer is not particularly limited, and specific examples thereof include polystyrene sulfonate, polyisoprene sulfonate, polyacrylate, polymaleic acid, polyitaconic acid, polyvinyl acetate, polyvinyl alcohol, polyglycerin, polyvinyl pyrrolidone, a copolymer of isoprene sulfonic acid and acrylic acid, polyvinyl pyrrolidone polyacrylic acid copolymer, polyvinyl pyrrolidone vinyl acetate copolymer, a salt of naphthalene sulfonic acid formalin condensate, diallylamine hydrochloride sulfur dioxide copolymer, carboxymethyl cellulose, a salt of carboxymethyl cellulose, hydroxyethyl cellulose, hydroxypropyl cellulose, α-cellulose, β-cellulose, γ-cellulose, pullulan, chitosan, and a chitosan salt. For these water-soluble polymers, one type thereof may be used alone, or two or more types thereof may be used in combination.

A content of the water-soluble polymer in the polishing composition is preferably 0.0001% by mass or more, and more preferably 0.001% by mass or more. As the content of the water-soluble polymer is increased, redispersibility of the magnetic particles and the abrasive particles becomes better. In addition, the content of the water-soluble polymer in the polishing composition is preferably 1% by mass or less, and more preferably 0.1% by mass or less. As the content of the water-soluble polymer is decreased, a residual amount of the polymer on the polished surface is decreased, and a cleaning efficiency is further improved.

(5) Regarding Preservative and Antifungal Agent

A preservative and an antifungal agent may be contained in the polishing composition of the present embodiment. There are no particular limitations on types of the preservative and the antifungal agent, and specific examples thereof include isothiazoline-based preservatives such as 2-methyl-4-isothiazolin-3-one and 5-chloro-2-methyl-4-isothiazolin-3-one, paraoxybenzoic acid esters, and phenoxyethanol. For these preservatives and antifungal agents, one type thereof may be used alone, or two or more types thereof may be used in combination.

9. Regarding Method for Producing Polishing Composition

A method for producing the polishing composition of the present embodiment is not particularly limited, and it is possible to produce the polishing composition, for example, by stirring and mixing the respective components such as magnetic particles and antioxidant in water. A temperature at which the respective components are mixed is not particularly limited. The temperature is preferably 10° C. to 40° C., and heating may be carried out to increase a dissolution rate. In addition, a mixing time is not particularly limited.

Alternatively, the polishing composition may be produced by separately preparing a first component containing magnetic particles and a second component containing water, and mixing these two components. At this time, the antioxidant may be contained in the first component, in the second component, or in both components. Alternatively again, the antioxidant may be added to a mixture of the first component and the second component, or the first component, the second component, and the antioxidant may be mixed at the same time.

In a case where the magnetic particles and water are brought into contact with each other, oxidation of the magnetic particles progresses. Thus, it is preferable to carry out mixing of the first component and the second component before polishing the object to be polished, and it is more preferable to carry out the mixing at a timing which is close to a polishing initiation time as much as possible. Specifically, mixing of the first component and the second component is preferably carried out within one week before a polishing initiation time, more preferably within two days before the polishing initiation time, even more preferably within 24 hours before the polishing initiation time, and particularly preferably immediately (for example, within 1 hour, within 30 minutes) before the polishing initiation time.

In a case where a step of mixing the first component and the second component is carried out immediately before the polishing initiation time, almost no oxidation of the magnetic particles progresses, so that almost no decrease in polishing performance of the polishing composition occurs over time. Therefore, in a case where the object to be polished is polished using the polishing composition produced in such a manner, it is possible to carry out polishing for finishing the object to be polished with a high accuracy. In addition, it is possible to suppress a generation amount of hydrogen to a small amount. Furthermore, since the prepared first component and second component are stored separately and mixed immediately before the polishing initiation time, an extremely excellent storage stability is exhibited, and it is also possible to store the components over a long period of time.

10. Regarding Magnetic Polishing Method

A method for polishing the object to be polished by using the polishing composition of the present embodiment is not particularly limited. It is possible to use the polishing composition of the present embodiment for a magnetic polishing method, because the polishing composition is capable of forming a brush-like magnetic cluster along a magnetic force line due to application of a magnetic field.

In a case where the magnetic cluster that contains the magnetic particles is formed in the polishing composition due to application of the magnetic field, the magnetic cluster is brought into contact with a surface to be polished of the object to be polished, and then one or both of the object to be polished and the magnetic cluster are moved, so that the magnetic cluster and the surface to be polished of the object to be polished are brought into sliding contact with each other. By doing so, the surface to be polished of the object to be polished is polished by a shear stress at a contact position between the magnetic cluster and the surface to be polished of the object to be polished. The magnetic cluster is deformable so as to follow even a complicated shape or an irregular shape. Thus, it is possible not only to polish a flat surface but also to polish a surface of a three-dimensional shape.

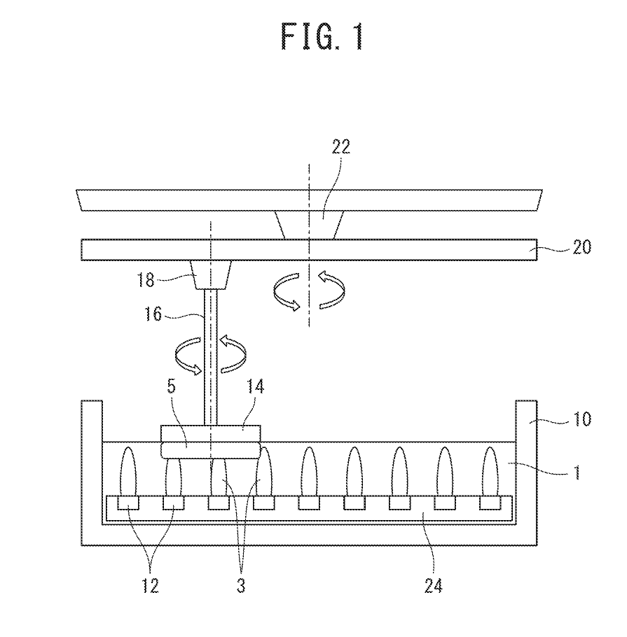

Here, an example of the magnetic polishing method will be described with reference to FIG. 1. A magnetic polishing apparatus illustrated in FIG. 1 includes a container 10 that contains a polishing composition 1, a magnetic field applying part 12 that applies a magnetic field to the polishing composition 1 contained in the container 10, a holding part 14 that holds an object 5 to be polished, a first driving part 18 for rotating a rotation shaft 16 coupled to the holding part 14, a disk 20 to which the rotation shaft 16 is rotatably connected, and a second driving part 22 for rotating the disk 20 so that the holding part 14 is revolved.

The magnetic field applying part 12 is provided on a disk-shaped polishing platen 24 installed at a bottom of the container 10, and is adapted to enable a magnetic field to be applied to the polishing composition 1 contained in the container 10. The polishing platen 24 may be installed in the container 10 or may be installed outside the container 10 as long as it is possible for the polishing platen 24 to apply a magnetic field to the polishing composition 1 contained in the container 10. A configuration of the magnetic field applying part 12 is not particularly limited, and it is possible that the magnetic field applying part 12 is configured to have, for example, a permanent magnet or an electromagnet. In the example of FIG. 1, the magnetic field applying part 12 is configured to have a permanent magnet, and a plurality of permanent magnets is attached to the polishing platen 24. A strength of a magnetic field applied is not particularly limited, and adjustment may be done so that a surface magnetic flux density at a surface of the magnetic field applying part 12 which is in contact with the magnetic cluster 3 is 100 mT to 3,000 mT (that is, 1,000 gauss to 300,000 gauss).

In addition, in order to cause magnetic force lines to be directed in a direction (hereinafter also referred to as “vertical direction”) perpendicular to a plate surface of the polishing platen 24, all of the permanent magnets are mounted on the polishing platen 24 with magnetic poles of the same kind being directed in the same direction side which is a vertical direction. Therefore, the magnetic cluster 3 formed in the polishing composition 1 extends in a direction perpendicular to the plate surface of the polishing platen 24. However, the permanent magnets may be mounted on the polishing platen 24 so that the magnetic force lines are directed in a direction horizontal to the plate surface of the polishing platen 24. For example, in a case where the permanent magnets are divided into a permanent magnet mounted so that an S pole (which may be an N pole) is directed in one direction side (for example, an upper side) which is a vertical direction and a permanent magnet mounted so that an S pole (which may be an N pole) is directed in the other direction side (for example, a lower side) which is a vertical direction, and S poles of the adjacent permanent magnets are directed in opposite directions to each other in a vertical direction, the magnetic force lines are directed in a direction horizontal to the plate surface of the polishing platen 24.

The object 5 to be polished held by the holding part 14 is disposed with an interval in a vertical direction away from the polishing platen 24. At this time, the interval in a vertical direction between the object 5 to be polished and the polishing platen 24 is set to a size such that the object 5 to be polished and the magnetic cluster 3 are brought into contact with each other. Next, the rotation shaft 16 extending in a vertical direction is rotated by the first driving part 18, and the disk 20 parallel to the polishing platen 24 is rotated by the second driving part 22. The rotation shaft 16 is mounted on an outer diameter side of the disk 20 rather than a center thereof. Thus, by rotating the disk 20 while rotating the rotation shaft 16, it is possible to rotate and revolve the object 5 to be polished (holding part 14) while keeping the object 5 to be polished parallel to the plate surface of the polishing platen 24. It is possible that the first driving part 18 and the second driving part 22 are configured to have, for example, a motor.

Due to such rotational motion and revolutional motion of the object 5 to be polished, the object 5 to be polished and the magnetic cluster 3 move relative to each other while being in contact with each other. Thus, the magnetic cluster 3 and a surface to be polished of the object 5 to be polished are brought into sliding contact with each other, and the surface to be polished of the object 5 to be polished is finished with a high accuracy (for example, mirror-finished).

It is possible to use a CNC grinding apparatus as the magnetic polishing apparatus. In addition, the magnetic polishing apparatus of FIG. 1 has a configuration in which the object 5 to be polished moves and the magnetic field applying part 12 does not move. However, contrary to this, a configuration in which the magnetic field applying part 12 moves and the object 5 to be polished does not move may be adopted. Alternatively, a magnetic polishing apparatus configured such that both the object 5 to be polished and the magnetic field applying part 12 move may be adopted.

The polishing may be carried out in a plurality of stages such as first carrying out a rough/intermediate final polishing in which emphasis is placed on a processing efficiency and then a final polishing in which emphasis is placed on a surface quality.

### EXAMPLES

Hereinafter, the present invention will be more specifically described by way of examples. First, with respect to various antioxidants shown in Tables 1 to 6, investigations were made for a performance of suppressing oxidation of iron particles which are magnetic particles and a performance of suppressing aggregation of iron particles which are magnetic particles. Evaluation methods will be described below.

An appropriate amount of potassium hydroxide or nitric acid was added to a mixture of 0.25 parts by mass of each antioxidant and 59.75 parts by mass of water so as to adjust a pH to 9.5, and 40 parts by mass of iron particles having an average primary particle diameter of 3 μm were added to prepare a slurry.

400 g of the slurry was placed in a container having a volume of 500 mL, and stored for 72 hours at respective temperatures of 23° C., 35° C., and 43° C. Then, a concentration of hydrogen in a gas in the container was measured with a gas detector (GP-1000, manufactured by RIKEN KEIKI Co., Ltd.). The results are shown in Tables 1 to 6. A case where a concentration of hydrogen in a gas in the container after storage at a temperature of 35° C. for 72 hours is less than 0.01% by volume is considered as acceptable.

Next, 400 g of the slurry is placed in a container having a volume of 500 mL and stored at respective temperatures of 23° C., 35° C., and 43° C. for 72 hours. By doing so, aggregated sediments of iron particles are formed. Thus, whether or not redispersion occurs was evaluated by shaking the volume to disintegrate the aggregated sediments of iron particles. The results are shown in Tables 1 to 6. In Tables 1 to 6, a case where the aggregated sediments of iron particles are disintegrated and redispersed is indicated by “0”, and a case where the aggregated sediments of iron particles are not redispersed is indicated by “x”. A case where the aggregated sediments generated by being stored at a temperature of 35° C. for 72 hours are redispersed is considered as acceptable.

TABLE 1

| | | Hydrogen gas generation amount (%) | | | Redispersibility | | |
|---|---|---|---|---|---|---|---|
| | | 23° C. × | 35° C. × | 43° C. × | 23° C. × | 35° C. × | 43° C. × |
| Classification | Compound name | 72 hours | 72 hours | 72 hours | 72 hours | 72 hours | 72 hours |
| Alkenyl succinic | Pentenyl succinic acid | <0.01 | <0.01 | >4 | ∘ | ∘ | x |
| acid derivative | | | | | | | |
| Alkenyl succinic | Octenyl succinic acid | <0.01 | <0.01 | >4 | ∘ | ∘ | x |
| acid derivative | | | | | | | |
| Alkenyl succinic | Decenyl succinic acid | <0.01 | <0.01 | >4 | ∘ | ∘ | x |
| acid derivative | | | | | | | |
| Alkenyl succinic | Dodecenyl succinic acid | <0.01 | <0.01 | >4 | ∘ | ∘ | x |
| acid derivative | | | | | | | |
| Alkenyl succinic | Pentadecenyl succinic acid | <0.01 | <0.01 | >4 | ∘ | ∘ | x |
| acid derivative | | | | | | | |
| Alkenyl succinic | N,N-Bis(methyl)octenyl succinamic acid | <0.01 | <0.01 | >4 | ∘ | ∘ | x |
| acid derivative | (Octenyl succinic acid dimethylamide) | | | | | | |
| Alkenyl succinic | N,N-Bis(ethyl)octenyl succinamic acid | <0.01 | <0.01 | >4 | ∘ | ∘ | x |
| acid derivative | (Octenyl succinic acid diethylamide) | | | | | | |
| Alkenyl succinic | N-(ethyl)octenyl succinamic acid | <0.01 | <0.01 | >4 | ∘ | ∘ | x |
| acid derivative | (Octenyl succinic acid ethylamide) | | | | | | |
| Alkenyl succinic | N,N-Bis(2-hydroxyethyl)octenyl succinamic acid | <0.01 | <0.01 | <0.01 | ∘ | ∘ | ∘ |
| acid derivative | (Octenyl succinic acid diethanolamide) | | | | | | |
| Alkenyl succinic | N,N-Bis(2-hydroxyethyl)dodecenyl succinamic acid | <0.01 | <0.01 | <0.01 | ∘ | ∘ | ∘ |
| acid derivative | (Dodecenyl succinic acid diethanolamide) | | | | | | |
| Alkenyl succinic | N,N-Bis(2-hydroxyethyl)pentadecenyl succinamic acid | <0.01 | <0.01 | <0.01 | ∘ | ∘ | ∘ |
| acid derivative | (Pentadecenyl succinic acid diethanolamide) | | | | | | |
| Alkenyl succinic | N,N-Bis(2-hydroxypropyl)octenyl succinamic acid | <0.01 | <0.01 | <0.01 | ∘ | ∘ | ∘ |
| acid derivative | (Octenyl succinic acid dipropanolamide) | | | | | | |
| Alkenyl succinic | N,N-Bis(2-hydroxypropyl)dodecenyl succinamic acid | <0.01 | <0.01 | <0.01 | ∘ | ∘ | ∘ |
| acid derivative | (Dodecenyl succinic acid dipropanolamide) | | | | | | |
| Alkenyl succinic | N,N-Bis(2-hydroxypropyl)pentadecenyl succinamic acid | <0.01 | <0.01 | <0.01 | ∘ | ∘ | ∘ |
| acid derivative | (Pentadecenyl succinic acid dipropanolamide) | | | | | | |
| Alkenyl succinic | N-(2-hydroxyethyl)octenyl succinamic acid | <0.01 | <0.01 | <0.01 | ∘ | ∘ | ∘ |
| acid derivative | (Octenyl succinic acid monoethanolamide) | | | | | | |
| Alkenyl succinic | N-(2-hydroxyethyl)dodecenyl succinamic acid | <0.01 | <0.01 | <0.01 | ∘ | ∘ | ∘ |
| acid derivative | (Dodecenyl succinic acid monoethanolamide) | | | | | | |
| Alkenyl succinic | N-(2-hydroxyethyl)pentadecenyl succinamic acid | <0.01 | <0.01 | <0.01 | ∘ | ∘ | ∘ |
| acid derivative | (Pentadecenyl succinic acid monoethanolamide) | | | | | | |
| Alkenyl succinic | N,N-Bis(polyoxyethylene)dodecenyl succinamic acid | <0.01 | <0.01 | <0.01 | ∘ | ∘ | ∘ |
| acid derivative | (Dodecenyl succinic acid bis(polyoxyethylene)) | | | | | | |
| Alkenyl succinic | N,N-Bis(polyoxypropylene)dodecenyl succinamic acid | <0.01 | <0.01 | <0.01 | ∘ | ∘ | ∘ |
| acid derivative | (Dodecenyl succinic acid bis(polyoxypropylene)) | | | | | | |
| Alkenyl succinic | N,N-Bis(2-hydroxyethyl)octenyl succinamide | <0.01 | <0.01 | <0.01 | ∘ | ∘ | ∘ |
| acid derivative | | | | | | | |
| Alkenyl succinic | N,N-Bis(2-hydroxyethyl)dodecenyl succinamide | <0.01 | <0.01 | <0.01 | ∘ | ∘ | ∘ |
| acid derivative | | | | | | | |
| Alkenyl succinic | N,N-Bis(2-hydroxyethyl)pentadecenyl succinamide | <0.01 | <0.01 | <0.01 | ∘ | ∘ | ∘ |
| acid derivative | | | | | | | |
| Alkenyl succinic | N,N-Bis(methyl)octenyl succinamide | <0.01 | <0.01 | >4 | ∘ | ∘ | x |
| acid derivative | | | | | | | |
| Alkenyl succinic | N,N-Bis(ethyl)octenyl succinamide | <0.01 | <0.01 | >4 | ∘ | ∘ | x |
| acid derivative | | | | | | | |
| Alkenyl succinic | N-(ethyl)octenyl succinamide | <0.01 | <0.01 | >4 | ∘ | ∘ | x |
| acid derivative | | | | | | | |
| Alkenyl succinic | N,N-Bis(polyoxyethylene)dodecenyl succinamide | <0.01 | <0.01 | <0.01 | ∘ | ∘ | ∘ |
| acid derivative | (Dodecenyl succinic acid amide bis(polyoxyethylene)) | | | | | | |

TABLE 2

| | | Hydrogen gas generation amount (%) | | | Redispersibility | | |
|---|---|---|---|---|---|---|---|
| | | 23° C. × | 35° C. × | 43° C. × | 23° C. × | 35° C. × | 43° C. × |
| Classification | Compound name | 72 hours | 72 hours | 72 hours | 72 hours | 72 hours | 72 hours |
| Bipyridine derivative | 2,2′-Bipyridyl | <0.01 | <0.01 | 1 | ∘ | ∘ | x |
| Bipyridine derivative | 2,2′-Bipyridine-4,4′-dimethanol | <0.01 | <0.01 | 2.6 | ∘ | ∘ | x |
| Bipyridine derivative | 6,6′-Dihydroxy-2,2′-bipyridine | <0.01 | <0.01 | 2.1 | ∘ | ∘ | x |
| Bipyridine derivative | 2,2′-Bipyridine-5,5′-dicarboxylic acid | <0.01 | <0.01 | 2.9 | ∘ | ∘ | x |
| Bipyridine derivative | 3-Hydroxy-4,4′-dimethyl-2,2′-bipyridyl | <0.01 | <0.01 | 1.8 | ∘ | ∘ | x |
| Bipyridine derivative | 6-Methoxy-2,2′-bipyridyl | <0.01 | <0.01 | 1 | ∘ | ∘ | x |
| Bipyridine derivative | 3,3′-Dihydroxy-2,2′-bipyridyl | <0.01 | <0.01 | 1 | ∘ | ∘ | x |
| Bipyridine derivative | 3-Carboxy-2,2′-bipyridyl | <0.01 | <0.01 | 1.1 | ∘ | ∘ | x |
| Bipyridine derivative | 4-Carboxy-2,2′-bipyridyl | <0.01 | <0.01 | 1 | ∘ | ∘ | x |
| Bipyridine derivative | 6-Carboxy-2,2′-bipyridyl | <0.01 | <0.01 | 1.2 | ∘ | ∘ | x |
| Bipyridine derivative | 6-Bromo-2,2′-bipyridyl | <0.01 | <0.01 | 1 | ∘ | ∘ | x |
| Bipyridine derivative | 6-Chloro-2,2′-bipyridyl | <0.01 | <0.01 | 1.1 | ∘ | ∘ | x |
| Bipyridine derivative | 6,6′-Diamino-2,2′-bipyridine | <0.01 | <0.01 | 1 | ∘ | ∘ | x |
| Bipyridine derivative | 6,6′-Dimethyl-2,2′-bipyridine | <0.01 | <0.01 | 1.3 | ∘ | ∘ | x |
| Bipyridine derivative | 6,6′-Disulfone-2,2′-bipyridine | <0.01 | <0.01 | 1.4 | ∘ | ∘ | x |
| Triazole derivative | 1,2,3-Triazole | <0.01 | <0.01 | <0.01 | ∘ | ∘ | ∘ |
| Triazole derivative | 1,2,4-Triazole | <0.01 | <0.01 | <0.01 | ∘ | ∘ | ∘ |
| Triazole derivative | 1-Methyl-1,2,4-triazole | <0.01 | <0.01 | <0.01 | ∘ | ∘ | ∘ |
| Triazole derivative | 3-Nitro-1,2,4-triazole | <0.01 | <0.01 | <0.01 | ∘ | ∘ | ∘ |
| Triazole derivative | 4-(1,2,4-Triazol-1-yl)phenol | <0.01 | <0.01 | <0.01 | ∘ | ∘ | ∘ |
| Triazole derivative | 3-Thiol-1,2,4-triazole | <0.01 | <0.01 | <0.01 | ∘ | ∘ | ∘ |
| Triazole derivative | 3-Bromo-5-nitro-1,2,4-triazole | <0.01 | <0.01 | <0.01 | ∘ | ∘ | ∘ |

TABLE 3

| | | Hydrogen gas generation amount (%) | | | Redispersibility | | |
|---|---|---|---|---|---|---|---|
| | | 23° C. × | 35° C. × | 43° C. × | 23° C. × | 35° C. × | 43° C. × |
| Classification | Compound name | 72 hours | 72 hours | 72 hours | 72 hours | 72 hours | 72 hours |
| Benzotriazole derivative | Benzotriazole | <0.01 | <0.01 | <0.01 | ∘ | ∘ | ∘ |
| Benzotriazole derivative | 2,2′-[[(Methyl-1H-benzotriazol-1- | <0.01 | <0.01 | <0.01 | ∘ | ∘ | ∘ |
| | yl)methyl]imino]bisethanol | | | | | | |
| Benzotriazole derivative | 5-Chlorobenzotriazole | <0.01 | <0.01 | 0.04 | ∘ | ∘ | ∘ |
| Benzotriazole derivative | 1H-Benzotriazole-1-methanol | <0.01 | <0.01 | <0.01 | ∘ | ∘ | ∘ |
| Benzotriazole derivative | 5-Methyl-1H-benzotriazole | <0.01 | <0.01 | 3.6 | ∘ | ∘ | x |
| Benzotriazole derivative | 5-Nitrobenzotriazole | <0.01 | <0.01 | <0.01 | ∘ | ∘ | ∘ |
| Benzotriazole derivative | 5,6-Dimethyl-1H-benzotriazole | <0.01 | <0.01 | <0.01 | ∘ | ∘ | ∘ |
| Benzotriazole derivative | 1-[N,N-Bis(hydroxyethyl)aminomethyl]benzo- | <0.01 | <0.01 | <0.01 | ∘ | ∘ | ∘ |
| | triazole | | | | | | |
| Benzotriazole derivative | 1-[N,N-Bis(hydroxyethyl)aminomethyl]- | <0.01 | <0.01 | <0.01 | ∘ | ∘ | ∘ |
| | 5-methylbenzotriazole | | | | | | |
| Benzotriazole derivative | 1-[N,N-Bis(hydroxyethyl)aminomethyl]- | <0.01 | <0.01 | <0.01 | ∘ | ∘ | ∘ |
| | 4-methylbenzotriazole | | | | | | |
| Phenanthroline derivative | 1,10-Phenanthroline | <0.01 | <0.01 | 0.1 | ∘ | ∘ | ∘ |
| Phenanthroline derivative | 4,7-Dihydroxy-1,10-phenanthroline | <0.01 | <0.01 | 0.1 | ∘ | ∘ | ∘ |
| Phenanthroline derivative | 2-Chloro-1,10-phenanthroline | <0.01 | <0.01 | <0.01 | ∘ | ∘ | ∘ |
| Phenanthroline derivative | 5-Chloro-1,10-phenanthroline | <0.01 | <0.01 | <0.01 | ∘ | ∘ | ∘ |
| Phenanthroline derivative | 2-Bromo-1,10-phenanthroline | <0.01 | <0.01 | <0.01 | ∘ | ∘ | ∘ |
| Phenanthroline derivative | 3-Bromo-1,10-phenanthroline | <0.01 | <0.01 | <0.01 | ∘ | ∘ | ∘ |
| Phenanthroline derivative | 5-Bromo-1,10-phenanthroline | <0.01 | <0.01 | <0.01 | ∘ | ∘ | ∘ |
| Phenanthroline derivative | 3,8-Dibromo-1,10-phenanthroline | <0.01 | <0.01 | <0.01 | ∘ | ∘ | ∘ |
| Phenanthroline derivative | 2,9-Dimethyl-1,10-phenanthroline | <0.01 | <0.01 | <0.01 | ∘ | ∘ | ∘ |
| Phenanthroline derivative | 2,9-Dimethyl-4,7-diphenyl-1,10-phenanthroline | <0.01 | <0.01 | <0.01 | ∘ | ∘ | ∘ |
| Phenanthroline derivative | 3,4,7,8-Tetramethyl-1,10-phenanthroline | <0.01 | <0.01 | <0.01 | ∘ | ∘ | ∘ |
| Phenanthroline derivative | 5-Amino-1,10-phenanthroline | <0.01 | <0.01 | 0.1 | ∘ | ∘ | ∘ |
| Phenanthroline derivative | 3,4,7,8-Tetrahydroxy-1,10-phenanthroline | <0.01 | <0.01 | <0.01 | ∘ | ∘ | ∘ |
| Phenanthroline derivative | 2,9-Dicarboxylic acid-1,10-phenanthroline | <0.01 | <0.01 | <0.01 | ∘ | ∘ | ∘ |
| Phenanthroline derivative | 5-Nitro-2,9-dicarboxylic acid-1,10-phenanthroline | <0.01 | <0.01 | <0.01 | ∘ | ∘ | ∘ |
| Phenanthroline derivative | 2,9-Disulfonic acid-1,10-phenanthroline | <0.01 | <0.01 | <0.01 | ∘ | ∘ | ∘ |
| Phenanthroline derivative | 4,7-Diphenyl-2,9-disulfonic acid-1,10- | <0.01 | <0.01 | <0.01 | ∘ | ∘ | ∘ |
| | phenanthroline | | | | | | |
| Phenanthroline derivative | 1,10-Phenanthroline-5,6-dione | <0.01 | <0.01 | <0.01 | ∘ | ∘ | ∘ |

TABLE 4

| | | Hydrogen gas generation amount (%) | | | Redispersibility | | |
|---|---|---|---|---|---|---|---|
| | | 23° C. × | 35° C. × | 43° C. × | 23° C. × | 35° C. × | 43° C. × |
| Classification | Compound name | 72 hours | 72 hours | 72 hours | 72 hours | 72 hours | 72 hours |
| Amine having no | Pyrrolidine | <0.01 | <0.01 | 1.6 | ∘ | ∘ | x |
| multiple bond | | | | | | | |
| Amine having no | Ethylenediamine | <0.01 | <0.01 | >4 | ∘ | ∘ | x |
| multiple bond | | | | | | | |
| Amine having no | N-Ethylethylenediamine | <0.01 | <0.01 | >4 | ∘ | ∘ | x |
| multiple bond | | | | | | | |
| Amine having no | 1,2-Diaminopropane | <0.01 | <0.01 | >4 | ∘ | ∘ | x |
| multiple bond | | | | | | | |
| Amine having no | Triethylenetetramine | <0.01 | <0.01 | <0.01 | ∘ | ∘ | ∘ |
| multiple bond | | | | | | | |
| Amine having no | Diethylenetriamine | <0.01 | <0.01 | >4 | ∘ | ∘ | x |
| multiple bond | | | | | | | |
| Amine having no | N-(2-Hydroxyethyl)ethylenediamine | <0.01 | <0.01 | 1.8 | ∘ | ∘ | x |
| multiple bond | | | | | | | |
| Amine having no | Diisopropanolamine | <0.01 | <0.01 | <0.01 | ∘ | ∘ | x |
| multiple bond | | | | | | | |
| Amine having no | Monoethanolamine | <0.01 | <0.01 | >4 | ∘ | ∘ | x |
| multiple bond | | | | | | | |
| Amine having no | Diethanolamine | <0.01 | <0.01 | 3.2 | ∘ | ∘ | x |
| multiple bond | | | | | | | |
| Amine having no | Triethanolamine | <0.01 | <0.01 | <0.01 | ∘ | ∘ | ∘ |
| multiple bond | | | | | | | |
| Amine having no | Diethylamine | <0.01 | <0.01 | 1.4 | ∘ | ∘ | x |
| multiple bond | | | | | | | |
| Amine having no | Triethylamine | <0.01 | <0.01 | 1.5 | ∘ | ∘ | x |
| multiple bond | | | | | | | |
| Amine having no | Nitrilotrimethylene phosphonic acid | <0.01 | <0.01 | >4 | ∘ | ∘ | x |
| multiple bond | | | | | | | |
| Amine having no | Nitrilotriacetic acid | <0.01 | <0.01 | >4 | ∘ | ∘ | x |
| multiple bond | | | | | | | |
| Amine having no | 1-Methylpyrrolidine | <0.01 | <0.01 | 1.6 | ∘ | ∘ | ∘ |
| multiple bond | | | | | | | |
| Amine having no | 2-Methylpyrrolidine | <0.01 | <0.01 | 1.6 | ∘ | ∘ | ∘ |
| multiple bond | | | | | | | |
| Amine having no | 1-(2-Hydroxyethyl)pyrrolidine | <0.01 | <0.01 | <0.01 | ∘ | ∘ | ∘ |
| multiple bond | | | | | | | |
| Amine having no | 2-(Hydroxymethyl)pyrrolidine | <0.01 | <0.01 | <0.01 | ∘ | ∘ | ∘ |
| multiple bond | | | | | | | |
| Amine having no | Piperidine | <0.01 | <0.01 | 1.6 | ∘ | ∘ | x |
| multiple bond | | | | | | | |
| Amine having no | 3,5-Dimethylpiperidine | <0.01 | <0.01 | 1.4 | ∘ | ∘ | ∘ |
| multiple bond | | | | | | | |
| Amine having no | 2-Ethylpiperidine | <0.01 | <0.01 | 1.5 | ∘ | ∘ | ∘ |
| multiple bond | | | | | | | |
| Amine having no | 3-Quinuclidinol | <0.01 | <0.01 | 1.2 | ∘ | ∘ | ∘ |
| multiple bond | | | | | | | |
| Amine having no | N,N-Diethylethylenediamine | <0.01 | <0.01 | >4 | ∘ | ∘ | x |
| multiple bond | | | | | | | |
| Amine having no | N,N′-Diethylethylenediamine | <0.01 | <0.01 | >4 | ∘ | ∘ | x |
| multiple bond | | | | | | | |
| Amine having no | N,N,N′,N′-Tetramethylethylenediamine | <0.01 | <0.01 | >4 | ∘ | ∘ | x |
| multiple bond | | | | | | | |
| Amine having no | N,N′-Bis(2-hydroxyethyl)ethylenediamine | <0.01 | <0.01 | <0.01 | ∘ | ∘ | ∘ |
| multiple bond | | | | | | | |
| Amine having no | N,N,N′,N′-Tetrakis(2-hydroxyethyl)ethylenediamine | <0.01 | <0.01 | <0.01 | ∘ | ∘ | ∘ |
| multiple bond | | | | | | | |
| Amine having no | Piperazine | <0.01 | <0.01 | >4 | ∘ | ∘ | x |
| multiple bond | | | | | | | |
| Amine having no | 1-(2-hydroxyethyl)piperazine | <0.01 | <0.01 | <0.01 | ∘ | ∘ | ∘ |
| multiple bond | | | | | | | |
| Amine having no | N,N,N′,N″,N″-Pentamethyldiethylenetriamine | <0.01 | <0.01 | >4 | ∘ | ∘ | x |
| multiple bond | | | | | | | |
| Amine having no | N,N,N′,N″,N″-Pentakis(2- | <0.01 | <0.01 | >4 | ∘ | ∘ | x |
| multiple bond | hydroxypropyl)diethylenetriamine | | | | | | |
| Amine having no | 3,3′-diaminodipropylamine | <0.01 | <0.01 | >4 | ∘ | ∘ | x |
| multiple bond | | | | | | | |
| Amine having no | N-(3-Aminopropyl)-N-methyl-1,3-propanediamine | <0.01 | <0.01 | >4 | ∘ | ∘ | x |
| multiple bond | | | | | | | |
| Amine having no | N″[3-(Dimethylamino)propyl]-N,N-dimethyl-1,3- | <0.01 | <0.01 | >4 | ∘ | ∘ | x |
| multiple bond | propanediamine | | | | | | |
| Amine having no | N-(2-Aminoethyl)piperazine | <0.01 | <0.01 | 1.6 | ∘ | ∘ | ∘ |
| multiple bond | | | | | | | |
| Amine having no | 1,4,7-Triazacyclononane | <0.01 | <0.01 | 1.2 | ∘ | ∘ | ∘ |
| multiple bond | | | | | | | |
| Amine having no | N,N,N′,N″,N″-Pentakis(2- | <0.01 | <0.01 | <0.01 | ∘ | ∘ | ∘ |
| multiple bond | hydroxypropyl)diethylenetriamine | | | | | | |
| Amine having no | N,N,N′,N″,N′″,N′″-Hexamethyltriethylenetetramine | <0.01 | <0.01 | <0.01 | ∘ | ∘ | ∘ |
| multiple bond | | | | | | | |
| Amine having no | 1,4-Bis(3-aminopropyl)piperazine | <0.01 | <0.01 | <0.01 | ∘ | ∘ | ∘ |
| multiple bond | | | | | | | |
| — | Benzotriazole + triethylenetetramine | <0.01 | <0.01 | <0.01 | ∘ | ∘ | ∘ |

TABLE 5

| | | Hydrogen gas generation amount (%) | | | Redispersibility | | |
|---|---|---|---|---|---|---|---|
| | | 23° C. × | 35° C. × | 43° C. × | 23° C. × | 35° C. × | 43° C. × |
| Classification | Compound name | 72 hours | 72 hours | 72 hours | 72 hours | 72 hours | 72 hours |
| Blank | — | 0.08 | >4 | >4 | x | x | x |
| Water-soluble polymer (nonion) | Polyethylene glycol (Mw 4000) | <0.01 | >4 | >4 | x | x | x |
| Water-soluble polymer (anion) | Sodium polyacrylate (Mw 3000) | 0.24 | >4 | >4 | x | x | x |
| Surfactant (anion) | Polyoxyethylene lauryl ether | <0.01 | >4 | >4 | x | x | x |
| | ammonium sulfate salt | | | | | | |
| Surfactant (nonion) | Polyoxyethylene lauryl ether | 0.12 | >4 | >4 | x | x | x |
| Tetrazole derivative | 1H-Tetrazole | >4 | >4 | >4 | x | x | x |
| Pyrazole derivative | Pyrazole | 1.32 | >4 | >4 | x | x | x |
| Imidazole derivative | Imidazole | <0.01 | 2.6 | >4 | ∘ | x | x |
| Indole derivative | Indole | 0.560 | >4 | >4 | x | x | x |
| Organophosphoric acid-based compound | Monobutyl phosphate | <0.01 | >4 | >4 | x | x | x |
| Organophosphoric acid-based compound | Dibutyl phosphate | 0.76 | 1.68 | >4 | ∘ | ∘ | x |
| Dicarboxylic acid amide | Succinamic acid | <0.01 | >4 | >4 | x | x | x |
| Dicarboxylic acid amide | Succinamide | <0.01 | >4 | >4 | ∘ | x | x |
| Dicarboxylic acid | Oxalic acid | >4 | >4 | >4 | x | x | x |
| Dicarboxylic acid | Malonic acid | >4 | >4 | >4 | x | x | x |
| Dicarboxylic acid | Succinic acid | >4 | >4 | >4 | x | x | x |
| Dicarboxylic acid | Glutaric acid | <0.01 | >4 | >4 | ∘ | x | x |
| Dicarboxylic acid | Adipic acid | 2.72 | >4 | >4 | x | x | x |
| Dicarboxylic acid | Pimelic acid | <0.01 | >4 | >4 | ∘ | x | x |
| Dicarboxylic acid | Suberic acid | >4 | >4 | >4 | x | x | x |
| Dicarboxylic acid | Azelaic acid | <0.01 | >4 | >4 | ∘ | x | x |
| Dicarboxylic acid | Sebacic acid | >4 | >4 | >4 | x | x | x |
| Dicarboxylic acid | Phthalic acid | <0.01 | >4 | >4 | ∘ | x | x |
| Dicarboxylic acid | Isophthalic acid | >4 | >4 | >4 | x | x | x |
| Dicarboxylic acid | Terephthalic acid | >4 | >4 | >4 | x | x | x |
| Fatty acid | Sodium oleate | <0.01 | 0.04 | >4 | x | x | x |
| Fatty acid | Palmitoleic acid | <0.01 | >4 | >4 | x | x | x |
| Fatty acid | Sodium elaidinate | <0.01 | >4 | >4 | x | x | x |
| Fatty acid | Sodium decanoate | <0.01 | >4 | >4 | x | x | x |

TABLE 6

| | | Hydrogen gas generation amount (%) | | | Redispersibility | | |
|---|---|---|---|---|---|---|---|
| | | 23° C. × | 35° C. × | 43° C. × | 23° C. × | 35° C. × | 43° C. × |
| Classification | Compound name | 72 hours | 72 hours | 72 hours | 72 hours | 72 hours | 72 hours |
| Benzothiazole derivative | (2-Benzothiazylthio)acetic acid | 0.4 | >4 | >4 | x | x | x |
| Benzothiazole derivative | 2-Mercaptobenzothiazole | 0.12 | >4 | >4 | x | x | x |
| Benzothiazole derivative | Sodium 2-mercaptobenzothiazole | >4 | >4 | >4 | x | x | x |
| Benzothiazole derivative | 3-(2-benzothiazylthio)propionic acid | 0.24 | >4 | >4 | x | x | x |
| Amine | Ammonia | >4 | >4 | >4 | x | x | x |
| Nitrogen-containing compound | 4,4′-Bipyridyl | <0.01 | >4 | >4 | x | x | x |
| Nitrogen-containing compound | Pyridine | <0.01 | >4 | >4 | x | x | x |
| Amino acid | glycine | 2.0 | >4 | >4 | x | x | x |
| Amino acid | DL-Alanine | <0.01 | >4 | >4 | x | x | x |
| Amino acid | DL-2-Phenylglycine | <0.01 | >4 | >4 | x | x | x |
| Amino acid | Pyrazinecarboxylic acid | >4 | >4 | >4 | x | x | x |
| — | Hexahydrophthalimide | <0.01 | >4 | >4 | x | x | x |
| — | Thioglycolic acid | >4 | >4 | >4 | x | x | x |
| Pyrazole derivative | 3-Methyl-5-pyrazolone | <0.01 | >4 | >4 | ∘ | x | x |
| Pyrazole derivative | 3,5-Dimethylpyrazole | >4 | >4 | >4 | x | x | x |
| — | Salicylic acid dihydrazide | 2.12 | >4 | >4 | x | x | x |
| — | Adipic acid dihydrazide | <0.01 | >4 | >4 | x | x | x |

From Tables 1 to 6, it can be seen that the alkenyl succinic acid derivative, the bipyridine derivative, the phenanthroline derivative, the triazole derivative, the benzotriazole derivative, and the amine having no carbon-carbon multiple bond in a molecule generate less hydrogen gas and suppress oxidation of the magnetic particles. In addition, it can be seen that the aggregated sediments of iron particles are redispersible.

On the contrary, phosphoric acid-based compounds commonly used as anticorrosive agents for iron, benzothiazole derivatives, nitrogen-containing compounds (tetrazole derivatives, pyrazole derivatives, imidazole derivatives, indole derivatives, hydrazide derivatives) used as antioxidants in metal polishing, and surfactants, water-soluble polymers, and the like used in polishing compositions for magnetic polishing in the related art have low performances of suppressing oxidation of the magnetic particles and of suppressing aggregation of the magnetic particles.

Next, a correlation between a concentration of the antioxidant and the above effects (oxidation suppressing effect and aggregation suppressing effect) was evaluated. The evaluation method is the same as the above, except that a concentration of the antioxidant is different. The results are shown in Table 7.

TABLE 7

| | | Concentration | Hydrogen gas generation amount (%) | | | | |
|---|---|---|---|---|---|---|---|
| | | (Parts by | 23° C. × | 35° C. × | 43° C. × | 60° C. × | 70° C. × |
| Classification | Compound name | mass) | 72 hours | 72 hours | 72 hours | 72 hours | 72 hours |
| Alkenyl succinic acid derivative | Octenyl succinic acid diethanolamide | 0.25 | <0.01 | <0.01 | <0.01 | >4 | >4 |
| | (N,N-Bis(2-hydroxyethyl)octenyl | 0.5 | <0.01 | <0.01 | <0.01 | <0.01 | >4 |
| | succinamic acid) | 1 | <0.01 | <0.01 | <0.01 | <0.01 | <0.01 |
| | | 5 | <0.01 | <0.01 | <0.01 | <0.01 | <0.01 |
| Triazole derivative | 1,2,4-Triazole | 0.25 | <0.01 | <0.01 | <0.01 | >4 | >4 |
| | | 0.5 | <0.01 | <0.01 | <0.01 | 1.24 | >4 |
| | | 1 | <0.01 | <0.01 | <0.01 | <0.01 | 2.1 |
| | | 5 | <0.01 | <0.01 | <0.01 | <0.01 | 0.5 |
| Benzotriazole derivative | Benzotriazole | 0.25 | <0.01 | <0.01 | <0.01 | >4 | >4 |
| | | 0.5 | <0.01 | <0.01 | <0.01 | <0.01 | >4 |
| | | 1 | <0.01 | <0.01 | <0.01 | <0.01 | 2.56 |
| | | 5 | <0.01 | <0.01 | <0.01 | <0.01 | <0.01 |
| Benzotriazole derivative | 5-Nitrobenzotriazole | 0.25 | <0.01 | <0.01 | <0.01 | <0.01 | >4 |
| | | 0.5 | <0.01 | <0.01 | <0.01 | <0.01 | 1.5 |
| | | 1 | <0.01 | <0.01 | <0.01 | <0.01 | <0.01 |
| | | 5 | <0.01 | <0.01 | <0.01 | <0.01 | <0.01 |
| Bipyridine derivative | 2,2′-Bipyridyl | 0.25 | <0.01 | <0.01 | 1 | >4 | >4 |
| | | 0.5 | <0.01 | <0.01 | <0.01 | <0.01 | >4 |
| | | 1 | <0.01 | <0.01 | <0.01 | <0.01 | <0.01 |
| | | 5 | <0.01 | <0.01 | <0.01 | <0.01 | <0.01 |
| Bipyridine derivative | 1,10-Phenanthroline | 0.25 | <0.01 | <0.01 | 0.12 | >4 | >4 |
| | | 0.5 | <0.01 | <0.01 | <0.01 | >4 | >4 |
| | | 1 | <0.01 | <0.01 | <0.01 | <0.01 | >4 |
| | | 5 | <0.01 | <0.01 | <0.01 | <0.01 | <0.01 |
| Amine having no multiple bond | Triethylenetetramine | 0.25 | <0.01 | <0.01 | <0.01 | >4 | >4 |
| | | 0.5 | <0.01 | <0.01 | <0.01 | >4 | >4 |
| | | 1 | <0.01 | <0.01 | <0.01 | <0.01 | >4 |
| | | 5 | <0.01 | <0.01 | <0.01 | <0.01 | <0.01 |
| Amine having no multiple bond | Triethanolamine | 0.25 | <0.01 | <0.01 | <0.01 | >4 | >4 |
| | | 0.5 | <0.01 | <0.01 | <0.01 | >4 | >4 |
| | | 1 | <0.01 | <0.01 | <0.01 | <0.01 | >4 |
| | | 5 | <0.01 | <0.01 | <0.01 | <0.01 | <0.01 |
| Blank | — | | 0.080 | >4 | >4 | >4 | >4 |
| Fatty acid | Sodium oleate | 0.25 | <0.01 | 0.04 | >4 | >4 | >4 |
| | | 0.5 | <0.01 | 0.06 | >4 | >4 | >4 |
| | | 1 | <0.01 | 0.12 | >4 | >4 | >4 |
| | | 5 | <0.01 | <0.01 | >4 | >4 | >4 |

| | |
|---|---|
| Concentration | Redispersibility |

| | | (Parts by | 23° C. × | 35° C. × | 43° C. × | 60° C. × | 70° C. × |
|---|---|---|---|---|---|---|---|
| Classification | Compound name | mass) | 72 hours | 72 hours | 72 hours | 72 hours | 72 hours |
| Alkenyl succinic acid derivative | Octenyl succinic acid diethanolamide | 0.25 | ∘ | ∘ | ∘ | x | x |
| | (N,N-Bis(2-hydroxyethyl)octenyl | 0.5 | ∘ | ∘ | ∘ | ∘ | x |
| | succinamic acid) | 1 | ∘ | ∘ | ∘ | ∘ | ∘ |
| | | 5 | ∘ | ∘ | ∘ | ∘ | ∘ |
| Triazole derivative | 1,2,4-Triazole | 0.25 | ∘ | ∘ | ∘ | x | x |
| | | 0.5 | ∘ | ∘ | ∘ | x | x |
| | | 1 | ∘ | ∘ | ∘ | ∘ | x |
| | | 5 | ∘ | ∘ | ∘ | ∘ | x |
| Benzotriazole derivative | Benzotriazole | 0.25 | ∘ | ∘ | ∘ | x | x |
| | | 0.5 | ∘ | ∘ | ∘ | ∘ | x |
| | | 1 | ∘ | ∘ | ∘ | ∘ | x |
| | | 5 | ∘ | ∘ | ∘ | ∘ | ∘ |
| Benzotriazole derivative | 5-Nitrobenzotriazole | 0.25 | ∘ | ∘ | ∘ | ∘ | x |
| | | 0.5 | ∘ | ∘ | ∘ | ∘ | x |
| | | 1 | ∘ | ∘ | ∘ | ∘ | ∘ |
| | | 5 | ∘ | ∘ | ∘ | ∘ | ∘ |
| Bipyridine derivative | 2,2′-Bipyridyl | 0.25 | ∘ | ∘ | x | x | x |
| | | 0.5 | ∘ | ∘ | ∘ | ∘ | x |
| | | 1 | ∘ | ∘ | ∘ | ∘ | ∘ |
| | | 5 | ∘ | ∘ | ∘ | ∘ | ∘ |
| Bipyridine derivative | 1,10-Phenanthroline | 0.25 | ∘ | ∘ | ∘ | x | x |
| | | 0.5 | ∘ | ∘ | ∘ | x | x |
| | | 1 | ∘ | ∘ | ∘ | ∘ | x |
| | | 5 | ∘ | ∘ | ∘ | ∘ | ∘ |
| Amine having no multiple bond | Triethylenetetramine | 0.25 | ∘ | ∘ | ∘ | x | x |
| | | 0.5 | ∘ | ∘ | ∘ | x | x |
| | | 1 | ∘ | ∘ | ∘ | ∘ | x |
| | | 5 | ∘ | ∘ | ∘ | ∘ | ∘ |
| Amine having no multiple bond | Triethanolamine | 0.25 | ∘ | ∘ | ∘ | x | x |
| | | 0.5 | ∘ | ∘ | ∘ | x | x |
| | | 1 | ∘ | ∘ | ∘ | ∘ | x |
| | | 5 | ∘ | ∘ | ∘ | ∘ | ∘ |
| Blank | — | | x | x | x | x | x |
| Fatty acid | Sodium oleate | 0.25 | x | x | x | x | x |
| | | 0.5 | x | x | x | x | x |
| | | 1 | x | x | x | x | x |
| | | 5 | x | x | x | x | x |

From Table 7, it can be seen that the above effects are improved as the alkenyl succinic acid derivative, the bipyridine derivative, the phenanthroline derivative, the triazole derivative, the benzotriazole derivative, and the amine having no carbon-carbon multiple bond in a molecule have higher concentrations. On the contrary, even in a case where antioxidants used in polishing compositions for magnetic polishing in the related art have higher concentrations, it was not possible to obtain a practically usable level of effect.

Next, an effect in a case where a plurality of types of antioxidants is used in combination was evaluated. The evaluation method is the same as the above, except that a plurality of types of antioxidants is used. The results are shown in Table 8.

TABLE 8

| | | Concentration | Hydrogen gas generation amount (%) | | | | |
|---|---|---|---|---|---|---|---|
| | | (Parts by | 23° C. × | 35° C. × | 43° C. × | 60° C. × | 70° C. × |
| Classification | Compound name | mass) | 72 hours | 72 hours | 72 hours | 72 hours | 72 hours |
| Alkenyl succinic acid | Octenyl succinic acid | 0.25 | <0.01 | <0.01 | <0.01 | <0.01 | >4 |
| derivative + | diethanolamide | | | | | | |
| amine having no multiple | Triethylenetetramine | 0.25 | | | | | |
| bond | | | | | | | |
| Bipyridine derivative + | 2,2′-Bipyridyl | 0.25 | <0.01 | <0.01 | <0.01 | <0.01 | >4 |
| amine having no multiple | Triethylenetetramine | 0.25 | | | | | |
| bond | | | | | | | |
| Triazole derivative + | 1,2,4-Triazole | 0.25 | <0.01 | <0.01 | <0.01 | <0.01 | >4 |
| amine having no multiple | Triethylenetetramine | 0.25 | | | | | |
| bond | | | | | | | |
| Triazole derivative + | Benzotriazole | 0.25 | <0.01 | <0.01 | <0.01 | <0.01 | >4 |
| amine having no multiple | Triethylenetetramine | 0.25 | | | | | |
| bond | | | | | | | |
| Blank | — | | 0.080 | >4 | >4 | >4 | >4 |
| | | Concentration | Redispersibility | | | | |
| | | (Parts by | 23° C. × | 35° C. × | 43° C. × | 60° C. × | 70° C. × |
| Classification | Compound name | mass) | 72 hours | 72 hours | 72 hours | 72 hours | 72 hours |
| Alkenyl succinic acid | Octenyl succinic acid | 0.25 | ∘ | ∘ | ∘ | ∘ | x |
| derivative + | diethanolamide | | | | | | |
| amine having no multiple | Triethylenetetramine | 0.25 | | | | | |
| bond | | | | | | | |
| Bipyridine derivative + | 2,2′-Bipyridyl | 0.25 | ∘ | ∘ | ∘ | ∘ | x |
| amine having no multiple | Triethylenetetramine | 0.25 | | | | | |
| bond | | | | | | | |
| Triazole derivative + | 1,2,4-Triazole | 0.25 | ∘ | ∘ | ∘ | ∘ | x |
| amine having no multiple | Triethylenetetramine | 0.25 | | | | | |
| bond | | | | | | | |
| Triazole derivative + | Benzotriazole | 0.25 | ∘ | ∘ | ∘ | ∘ | x |
| amine having no multiple | Triethylenetetramine | 0.25 | | | | | |
| bond | | | | | | | |
| Blank | — | | x | x | x | x | x |

Next, various objects to be polished were subjected to magnetic polishing using various polishing compositions, and polishing removal rates (unit of which is μm/min) were measured. In addition, investigations were made for whether or not hydrogen gas is generated during polishing, and whether or not the aggregated magnetic particles are redispersed after polishing. Furthermore, gloss and damages on surfaces to be polished of the objects to be polished were evaluated.

Evaluation of redispersibility was carried out by collecting the polishing compositions used for polishing and performing the same method (storage condition of which is 35° C., 72 hours) as in cases of Tables 1 to 6. In a case where an amount of hydrogen gas generated was less than 0.01% by volume, an evaluation that hydrogen gas is “not generated” was made. In addition, in a case where the magnetic particles in the polishing composition after polishing are readily redispersed by shaking, an evaluation that the redispersibility is “good” was made. In a case where redispersion by shaking is not sufficient and it is possible to achieve dispersion to a degree with no problem, an evaluation that the redispersibility is “allowable” was made. In a case where the aggregation which does not easily redisperse with shaking occurs, an evaluation that the redispersibility is “poor” was made.

The polishing removal rate was obtained from a difference between masses of the object to be polished before and after polishing, the masses having been measured with an electronic balance. For the gloss of the surface to be polished of the object to be polished, a case where a mirror surface is obtained was evaluated as “good”, a case where a mirror surface is obtained and partial cloudiness is observed was evaluated as “allowable”, and a case where a mirror surface is not obtained was evaluated as “poor”. For scratches on the surface to be polished of the object to be polished, a case where there are no damages that are visually identifiable was evaluated as “do not occur”, a case where there are 5 or fewer damages that are visually identifiable was evaluated as “allowable”, and a case where there are 6 or higher damages that are visually identifiable was evaluated as “poor”.

The polishing composition is a slurry obtained by adding an appropriate amount of potassium hydroxide or nitric acid to a mixture of 50 parts by mass of magnetic particles, 11.9 parts by mass of abrasive particles, 0.157 parts by mass of antioxidant, 1.25 parts by mass of α-cellulose, and 36.693 parts by mass of water, and adjusting a pH as described in Tables 9 to 23. However, in the examples in which numerical values are described in a column of oxidant, hydrogen peroxide is contained as the oxidant in each amount shown in Tables 9 to 23. In addition, in Examples in which a column of water-soluble polymer is blank, no α-cellulose is contained.

The magnetic particles are carbonyl iron or atomized iron, and average primary particle diameters thereof are as shown in Tables 9 to 23. The abrasive particles are silica or alumina, and average secondary particle diameters thereof are as shown in Tables 9 to 23. The antioxidants are as shown in Tables 9 to 23.

In Tables 9 to 23, TA is 1,2,4-triazole, BTA is benzotriazole, OSAA is N,N-bis(2-hydroxyethyl)octenyl succinamic acid (octenyl succinic acid diethanolamide), BTYE is 2,2′-[[(methyl-1H-benzotriazol-1-yl)methyl]imino]bisethanol, and PT is 1,10-phenanthroline.

TABLE 9

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example A1 | Silica | Carbonyl iron | OSAA | — | α- | 2.0 | 0.088 | Not | Allowable | Allowable | Allowable |
| | (100 nm) | (3 μm) | | | Cellulose | | | generated | | | |
| Example A2 | Silica | Carbonyl iron | OSAA | — | α- | 3.5 | 0.088 | Not | Allowable | Allowable | Allowable |
| | (100 nm) | (3 μm) | | | Cellulose | | | generated | | | |
| Example A3 | Silica | Carbonyl iron | OSAA | — | α- | 5.0 | 0.100 | Not | Good | Good | Do not |
| | (100 nm) | (3 μm) | | | Cellulose | | | generated | | | occur |
| Example A4 | Silica | Carbonyl iron | OSAA | — | α- | 7.0 | 0.138 | Not | Good | Good | Do not |
| | (100 nm) | (3 μm) | | | Cellulose | | | generated | | | occur |
| Example A5 | Silica | Carbonyl iron | OSAA | — | α- | 8.5 | 0.163 | Not | Good | Good | Do not |
| | (100 nm) | (3 μm) | | | Cellulose | | | generated | | | occur |
| Example A6 | Silica | Carbonyl iron | OSAA | — | α- | 9.5 | 0.238 | Not | Good | Good | Do not |
| | (100 nm) | (3 μm) | | | Cellulose | | | generated | | | occur |
| Example A7 | Silica | Carbonyl iron | OSAA | — | α- | 11.0 | 0.238 | Not | Good | Good | Do not |
| | (100 nm) | (3 μm) | | | Cellulose | | | generated | | | occur |
| Example A8 | Silica | Carbonyl iron | OSAA | — | — | 2.0 | 0.101 | Not | Allowable | Allowable | Allowable |
| | (100 nm) | (3 μm) | | | | | | generated | | | |
| Example A9 | Silica | Carbonyl iron | OSAA | — | — | 3.5 | 0.101 | Not | Allowable | Allowable | Allowable |
| | (100 nm) | (3 μm) | | | | | | generated | | | |
| Example A10 | Silica | Carbonyl iron | OSAA | — | — | 5.0 | 0.115 | Not | Good | Good | Do not |
| | (100 nm) | (3 μm) | | | | | | generated | | | occur |
| Example A11 | Silica | Carbonyl iron | OSAA | — | — | 7.0 | 0.158 | Not | Good | Good | Do not |
| | (100 nm) | (3 μm) | | | | | | generated | | | occur |
| Example A12 | Silica | Carbonyl iron | OSAA | — | — | 8.5 | 0.187 | Not | Good | Good | Do not |
| | (100 nm) | (3 μm) | | | | | | generated | | | occur |
| Example A13 | Silica | Carbonyl iron | OSAA | — | — | 9.5 | 0.273 | Not | Good | Good | Do not |
| | (100 nm) | (3 μm) | | | | | | generated | | | occur |
| Example A14 | Silica | Carbonyl iron | OSAA | — | — | 11.0 | 0.273 | Not | Good | Good | Do not |
| | (100 nm) | (3 μm) | | | | | | generated | | | occur |

TABLE 10

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example A15 | Silica | Carbonyl iron | OSAA | — | — | 9.5 | 0.138 | Not | Good | Good | Do not |
| | (100 nm) | (1.6 μm) | | | | | | generated | | | occur |
| Example A16 | Silica | Carbonyl iron | OSAA | — | — | 9.5 | 0.328 | Not | Good | Good | Do not |
| | (100 nm) | (5 μm) | | | | | | generated | | | occur |
| Example A17 | Silica | Carbonyl iron | OSAA | — | — | 9.5 | 0.590 | Not | Good | Good | Do not |
| | (100 nm) | (10 μm) | | | | | | generated | | | occur |
| Example A18 | Silica | Atomized iron | OSAA | — | — | 9.5 | 1.049 | Not | Good | Allowable | Allowable |
| | (100 nm) | (20 μm) | | | | | | generated | | | |
| Example A19 | Silica | Atomized iron | OSAA | — | — | 9.5 | 1.783 | Not | Allowable | Allowable | Poor |
| | (100 nm) | (50 μm) | | | | | | generated | | | |
| Example A20 | Silica | Atomized iron | OSAA | — | — | 9.5 | 2.622 | Not | Allowable | Poor | Poor |
| | (100 nm) | (100 μm) | | | | | | generated | | | |
| Example A21 | Alumina | Carbonyl iron | OSAA | — | — | 9.5 | 0.410 | Not | Good | Good | Do not |
| | (300 nm) | (3 μm) | | | | | | generated | | | occur |
| Example A22 | Alumina | Carbonyl iron | OSAA | — | — | 9.5 | 0.492 | Not | Good | Allowable | Do not |
| | (300 nm) | (5 μm) | | | | | | generated | | | occur |
| Example A23 | Alumina | Carbonyl iron | OSAA | — | — | 9.5 | 0.885 | Not | Good | Allowable | Allowable |
| | (300 nm) | (10 μm) | | | | | | generated | | | |
| Example A24 | Alumina | Atomized iron | OSAA | — | — | 9.5 | 1.573 | Not | Good | Allowable | Poor |
| | (300 nm) | (20 μm) | | | | | | generated | | | |
| Example A25 | Alumina | Atomized iron | OSAA | — | — | 9.5 | 2.674 | Not | Allowable | Poor | Poor |
| | (300 nm) | (50 μm) | | | | | | generated | | | |
| Example A26 | Alumina | Atomized iron | OSAA | — | — | 9.5 | 3.933 | Not | Allowable | Poor | Poor |
| | (300 nm) | (100 μm) | | | | | | generated | | | |

TABLE 11

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example A27 | Silica | Carbonyl iron | 2,2′- | — | α- | 9.5 | 0.190 | Not | Good | Good | Do not |
| | (100 nm) | (3 μm) | Bipyridyl | | Cellulose | | | generated | | | occur |
| Example A28 | Silica | Carbonyl iron | 2,2′- | — | — | 9.5 | 0.228 | Not | Allowable | Good | Do not |
| | (100 nm) | (3 μm) | Bipyridyl | | | | | generated | | | occur |
| Example A29 | Silica | Carbonyl iron | PT | — | α- | 9.5 | 0.190 | Not | Good | Good | Do not |
| | (100 nm) | (3 μm) | | | Cellulose | | | generated | | | occur |
| Example A30 | Silica | Carbonyl iron | PT | — | — | 9.5 | 0.228 | Not | Allowable | Good | Do not |
| | (100 nm) | (3 μm) | | | | | | generated | | | occur |
| Example A31 | Silica | Carbonyl iron | TA | — | α- | 2.0 | 0.060 | Not | Poor | Allowable | Allowable |
| | (100 nm) | (3 μm) | | | Cellulose | | | generated | | | |
| Example A32 | Silica | Carbonyl iron | TA | — | α- | 3.5 | 0.060 | Not | Poor | Allowable | Allowable |
| | (100 nm) | (3 μm) | | | Cellulose | | | generated | | | |
| Example A33 | Silica | Carbonyl iron | TA | — | α- | 5.0 | 0.070 | Not | Good | Good | Do not |
| | (100 nm) | (3 μm) | | | Cellulose | | | generated | | | occur |
| Example A34 | Silica | Carbonyl iron | TA | — | α- | 7.0 | 0.100 | Not | Good | Good | Do not |
| | (100 nm) | (3 μm) | | | Cellulose | | | generated | | | occur |
| Example A35 | Silica | Carbonyl iron | TA | — | α- | 8.5 | 0.120 | Not | Good | Good | Do not |
| | (100 nm) | (3 μm) | | | Cellulose | | | generated | | | occur |
| Example A36 | Silica | Carbonyl iron | TA | — | α- | 9.5 | 0.180 | Not | Good | Good | Do not |
| | (100 nm) | (3 μm) | | | Cellulose | | | generated | | | occur |
| Example A37 | Silica | Carbonyl iron | TA | — | α- | 11.0 | 0.180 | Not | Good | Good | Do not |
| | (100 nm) | (3 μm) | | | Cellulose | | | generated | | | occur |
| Example A38 | Alumina | Carbonyl iron | TA | — | — | 9.5 | 0.234 | Not | Good | Good | Do not |
| | (300 nm) | (3 μm) | | | | | | generated | | | occur |

TABLE 12

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example A39 | Silica | Carbonyl iron | BTA | — | α- | 2.0 | 0.070 | Not | Poor | Allowable | Allowable |
| | (100 nm) | (3 μm) | | | Cellulose | | | generated | | | |
| Example A40 | Silica | Carbonyl iron | BTA | — | α- | 3.5 | 0.070 | Not | Poor | Allowable | Allowable |
| | (100 nm) | (3 μm) | | | Cellulose | | | generated | | | |
| Example A41 | Silica | Carbonyl iron | BTA | — | α- | 5.0 | 0.080 | Not | Good | Good | Do not |
| | (100 nm) | (3 μm) | | | Cellulose | | | generated | | | occur |
| Example A42 | Silica | Carbonyl iron | BTA | — | α- | 7.0 | 0.110 | Not | Good | Good | Do not |
| | (100 nm) | (3 μm) | | | Cellulose | | | generated | | | occur |
| Example A43 | Silica | Carbonyl iron | BTA | — | α- | 8.5 | 0.130 | Not | Good | Good | Do not |
| | (100 nm) | (3 μm) | | | Cellulose | | | generated | | | occur |
| Example A44 | Silica | Carbonyl iron | BTA | — | α- | 9.5 | 0.190 | Not | Good | Good | Do not |
| | (100 nm) | (3 μm) | | | Cellulose | | | generated | | | occur |
| Example A45 | Silica | Carbonyl iron | BTA | — | α- | 10.5 | 0.190 | Not | Good | Good | Do not |
| | (100 nm) | (3 μm) | | | Cellulose | | | generated | | | occur |
| Example A46 | Silica | Carbonyl iron | BTA | — | α- | 11.5 | 0.150 | Not | Good | Good | Do not |
| | (100 nm) | (3 μm) | | | Cellulose | | | generated | | | occur |
| Example A47 | Silica | Carbonyl iron | BTA | — | — | 9.5 | 0.250 | Not | Allowable | Good | Do not |
| | (100 nm) | (3 μm) | | | | | | generated | | | occur |
| Example A48 | Silica | Carbonyl iron | BTA | — | — | 9.5 | 0.036 | Not | Good | Good | Do not |
| | (20 nm) | (3 μm) | | | | | | generated | | | occur |
| Example A49 | Silica | Carbonyl iron | BTA | — | — | 9.5 | 0.176 | Not | Good | Good | Do not |
| | (25 nm) | (3 μm) | | | | | | generated | | | occur |
| Example A50 | Silica | Carbonyl iron | BTA | — | — | 9.5 | 0.200 | Not | Good | Good | Do not |
| | (45 nm) | (3 μm) | | | | | | generated | | | occur |
| Example A51 | Silica | Carbonyl iron | BTA | — | — | 9.5 | 0.240 | Not | Good | Good | Do not |
| | (135 nm) | (3 μm) | | | | | | generated | | | occur |
| Example A52 | Silica | Carbonyl iron | BTA | — | — | 9.5 | 0.300 | Not | Good | Good | Do not |
| | (250 nm) | (3 μm) | | | | | | generated | | | occur |
| Example A53 | Silica | Carbonyl iron | BTA | — | — | 9.5 | 0.360 | Not | Good | Allowable | Allowable |
| | (400 nm) | (3 μm) | | | | | | generated | | | |
| Example A54 | Alumina | Carbonyl iron | BTA | — | α- | 9.5 | 0.240 | Not | Good | Good | Do not |
| | (300 nm) | (3 μm) | | | Cellulose | | | generated | | | occur |
| Example A55 | Alumina | Carbonyl iron | BTA | — | — | 9.5 | 0.450 | Not | Good | Good | Do not |
| | (300 nm) | (3 μm) | | | | | | generated | | | occur |
| Example A56 | Alumina | Carbonyl iron | BTA | — | — | 9.5 | 0.563 | Not | Good | Good | Allowable |
| | (500 nm) | (3 μm) | | | | | | generated | | | |
| Example A57 | Alumina | Carbonyl iron | BTA | — | — | 9.5 | 1.350 | Not | Good | Good | Poor |
| | (1,300 nm) | (3 μm) | | | | | | generated | | | |

TABLE 13

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example A58 | Silica | Carbonyl iron | 5-Methyl- | — | α- | 9.5 | 0.190 | Not | Good | Good | Do not |
| | (100 nm) | (3 μm) | benzotriazole | | Cellulose | | | generated | | | occur |
| Example A59 | Silica | Carbonyl iron | BTYE | — | α- | 9.5 | 0.200 | Not | Good | Good | Do not |
| | (100 nm) | (3 μm) | | | Cellulose | | | generated | | | occur |
| Example A60 | Silica | Carbonyl iron | Ethylenediamine | — | α- | 9.5 | 0.190 | Not | Good | Good | Do not |
| | (100 nm) | (3 μm) | | | Cellulose | | | generated | | | occur |
| Example A61 | Silica | Carbonyl iron | Triethylene- | — | α- | 9.5 | 0.190 | Not | Good | Good | Do not |
| | (100 nm) | (3 μm) | tetramine | | Cellulose | | | generated | | | occur |
| Example A62 | Silica | Carbonyl iron | Diethylene- | — | α- | 9.5 | 0.190 | Not | Good | Good | Do not |
| | (100 nm) | (3 μm) | triamine | | Cellulose | | | generated | | | occur |
| Example A63 | Silica | Carbonyl iron | Nitrilotri- | — | α- | 9.5 | 0.190 | Not | Good | Good | Do not |
| | (100 nm) | (3 μm) | methylene | | Cellulose | | | generated | | | occur |
| | | | phosphonic acid | | | | | | | | |
| Example A64 | Silica | Carbonyl iron | Benzotriazole | 0.001 | α- | 9.5 | 0.175 | Not | Good | Good | Do not |
| | (100 nm) | (3 μm) | | | Cellulose | | | generated | | | occur |
| Example A65 | Silica | Carbonyl iron | Benzotriazole | 0.01 | α- | 9.5 | 0.160 | Not | Good | Good | Do not |
| | (100 nm) | (3 μm) | | | Cellulose | | | generated | | | occur |
| Example A66 | — | Carbonyl iron | OSAA | — | — | 9.5 | 0.374 | Not | Good | Good | Allowable |
| | | (3 μm) | | | | | | generated | | | |
| Example A67 | — | Carbonyl iron | BTA | — | — | 9.5 | 0.325 | Not | Good | Good | Allowable |
| | | (3 μm) | | | | | | generated | | | |
| Comparative | Silica | Carbonyl iron | — | — | α- | 9.5 | 0.080 | Generated | Poor | Poor | Poor |
| Example A1 | (100 nm) | (3 μm) | | | Cellulose | | | | | | |
| Comparative | Silica | Carbonyl iron | Sodium | — | α- | 9.5 | 0.100 | Generated | Poor | Allowable | Allowable |
| Example A2 | (100 nm) | (3 μm) | oleate | | Cellulose | | | | | | |
| Comparative | Silica | Carbonyl iron | Monobutyl | — | α- | 9.5 | 0.120 | Generated | Poor | Poor | Poor |
| Example A3 | (100 nm) | (3 μm) | phosphate | | Cellulose | | | | | | |

TABLE 14

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example B1 | Silica | Carbonyl iron | OSAA | — | — | 2.0 | 0.045 | Not | Allowable | Allowable | Allowable |
| | (100 nm) | (3 μm) | | | | | | generated | | | |
| Example B2 | Silica | Carbonyl iron | OSAA | — | — | 9.5 | 0.055 | Not | Good | Good | Good |
| | (100 nm) | (3 μm) | | | | | | generated | | | |
| Example B3 | Silica | Carbonyl iron | OSAA | 0.01 | — | 9.5 | 0.076 | Not | Good | Good | Good |
| | (100 nm) | (3 μm) | | | | | | generated | | | |
| Example B4 | Alumina | Carbonyl iron | OSAA | — | — | 9.5 | 0.099 | Not | Good | Allowable | Good |
| | (300 nm) | (3 μm) | | | | | | generated | | | |
| Example B5 | Silica | Carbonyl iron | PT | — | — | 2.0 | 0.040 | Not | Allowable | Allowable | Allowable |
| | (100 nm) | (3 μm) | | | | | | generated | | | |
| Example B6 | Silica | Carbonyl iron | PT | — | — | 9.5 | 0.050 | Not | Good | Good | Good |
| | (100 nm) | (3 μm) | | | | | | generated | | | |
| Example B7 | Silica | Carbonyl iron | PT | 0.01 | — | 9.5 | 0.070 | Not | Good | Good | Good |
| | (100 nm) | (3 μm) | | | | | | generated | | | |
| Example B8 | Alumina | Carbonyl iron | PT | — | — | 9.5 | 0.090 | Not | Good | Allowable | Good |
| | (300 nm) | (3 μm) | | | | | | generated | | | |
| Example B9 | Silica | Carbonyl iron | BTA | — | — | 2.0 | 0.040 | Not | Allowable | Allowable | Allowable |
| | (100 nm) | (3 μm) | | | | | | generated | | | |
| Example B10 | Silica | Carbonyl iron | BTA | — | — | 9.5 | 0.050 | Not | Good | Good | Good |
| | (100 nm) | (3 μm) | | | | | | generated | | | |
| Example B11 | Silica | Carbonyl iron | BTA | 0.01 | — | 9.5 | 0.070 | Not | Good | Good | Good |
| | (100 nm) | (3 μm) | | | | | | generated | | | |
| Example B12 | Alumina | Carbonyl iron | BTA | — | — | 9.5 | 0.090 | Not | Good | Allowable | Good |
| | (300 nm) | (3 μm) | | | | | | generated | | | |
| Comparative | Silica | Carbonyl iron | — | — | — | 9.5 | 0.030 | Generated | Poor | Poor | Poor |
| Example B1 | (100 nm) | (3 μm) | | | | | | | | | |

TABLE 15

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example C1 | Silica | Carbonyl iron | OSAA | — | — | 2.0 | 0.054 | Not | Allowable | Allowable | Allowable |
| | (100 nm) | (3 μm) | | | | | | generated | | | |
| Example C2 | Silica | Carbonyl iron | OSAA | — | — | 9.5 | 0.066 | Not | Good | Good | Good |
| | (100 nm) | (3 μm) | | | | | | generated | | | |
| Example C3 | Silica | Carbonyl iron | OSAA | 0.01 | — | 9.5 | 0.105 | Not | Good | Good | Good |
| | (100 nm) | (3 μm) | | | | | | generated | | | |
| Example C4 | Alumina | Carbonyl iron | OSAA | — | — | 9.5 | 0.119 | Not | Good | Allowable | Good |
| | (300 nm) | (3 μm) | | | | | | generated | | | |
| Example C5 | Silica | Carbonyl iron | PT | — | — | 2.0 | 0.048 | Not | Allowable | Allowable | Allowable |
| | (100 nm) | (3 μm) | | | | | | generated | | | |
| Example C6 | Silica | Carbonyl iron | PT | — | — | 9.5 | 0.060 | Not | Good | Good | Good |
| | (100 nm) | (3 μm) | | | | | | generated | | | |
| Example C7 | Silica | Carbonyl iron | PT | 0.01 | — | 9.5 | 0.950 | Not | Good | Good | Good |
| | (100 nm) | (3 μm) | | | | | | generated | | | |
| Example C8 | Alumina | Carbonyl iron | PT | — | — | 9.5 | 0.108 | Not | Good | Allowable | Good |
| | (300 nm) | (3 μm) | | | | | | generated | | | |
| Example C9 | Silica | Carbonyl iron | BTA | — | — | 2.0 | 0.048 | Not | Allowable | Allowable | Allowable |
| | (100 nm) | (3 μm) | | | | | | generated | | | |
| Example C10 | Silica | Carbonyl iron | BTA | — | — | 9.5 | 0.060 | Not | Good | Good | Good |
| | (100 nm) | (3 μm) | | | | | | generated | | | |
| Example C11 | Silica | Carbonyl iron | BTA | 0.01 | — | 9.5 | 1.020 | Not | Good | Good | Good |
| | (100 nm) | (3 μm) | | | | | | generated | | | |
| Example C12 | Alumina | Carbonyl iron | BTA | — | — | 9.5 | 0.108 | Not | Good | Allowable | Good |
| | (300 nm) | (3 μm) | | | | | | generated | | | |
| Comparative | Silica | Carbonyl iron | — | — | — | 9.5 | 0.036 | Generated | Poor | Poor | Poor |
| Example C1 | (100 nm) | (3 μm) | | | | | | | | | |

TABLE 16

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example D1 | Silica | Carbonyl iron | OSAA | — | — | 9.5 | 0.036 | Not | Good | Good | Good |
| | (100 nm) | (3 μm) | | | | | | generated | | | |
| Example D2 | Silica | Carbonyl iron | PT | — | — | 9.5 | 0.027 | Not | Good | Good | Good |
| | (100 nm) | (3 μm) | | | | | | generated | | | |
| Example D3 | Silica | Carbonyl iron | PT | 0.01 | — | 9.5 | 0.550 | Not | Good | Good | Good |
| | (100 nm) | (3 μm) | | | | | | generated | | | |
| Comparative | Silica | Carbonyl iron | — | — | — | 9.5 | 0.005 | Generated | Poor | Poor | Poor |
| Example D1 | (100 nm) | (3 μm) | | | | | | | | | |

TABLE 17

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example E1 | Silica | Carbonyl iron | OSAA | — | — | 2.0 | 0.036 | Not | Allowable | Allowable | Good |
| | (100 nm) | (5 μm) | | | | | | generated | | | |
| Example E2 | Silica | Carbonyl iron | OSAA | — | — | 7.0 | 0.045 | Not | Good | Allowable | Good |
| | (100 nm) | (5 μm) | | | | | | generated | | | |
| Example E3 | Silica | Carbonyl iron | OSAA | — | — | 9.5 | 0.050 | Not | Good | Good | Good |
| | (100 nm) | (5 μm) | | | | | | generated | | | |
| Example E4 | Silica | Carbonyl iron | OSAA | 0.01 | — | 9.5 | 0.085 | Not | Good | Good | Good |
| | (100 nm) | (5 μm) | | | | | | generated | | | |
| Example E5 | Alumina | Carbonyl iron | OSAA | — | — | 9.5 | 0.110 | Not | Good | Good | Good |
| | (300 nm) | (5 μm) | | | | | | generated | | | |
| Example E6 | Alumina | Carbonyl iron | OSAA | — | — | 9.5 | 0.572 | Not | Good | Good | Good |
| | (300 nm) | (10 μm) | | | | | | generated | | | |
| Example E7 | Alumina | Atomized iron | OSAA | — | — | 9.5 | 1.196 | Not | Good | Allowable | Occur |
| | (300 nm) | (50 μm) | | | | | | generated | | | |
| Example E8 | Silica | Carbonyl iron | PT | — | — | 2.0 | 0.036 | Not | Allowable | Allowable | Good |
| | (100 nm) | (5 μm) | | | | | | generated | | | |
| Example E9 | Silica | Carbonyl iron | PT | — | — | 9.5 | 0.050 | Not | Good | Good | Good |
| | (100 nm) | (5 μm) | | | | | | generated | | | |
| Example E10 | Silica | Carbonyl iron | PT | 0.01 | — | 9.5 | 0.060 | Not | Good | Good | Good |
| | (100 nm) | (5 μm) | | | | | | generated | | | |
| Example E11 | Alumina | Carbonyl iron | PT | — | — | 9.5 | 0.100 | Not | Good | Good | Good |
| | (300 nm) | (5 μm) | | | | | | generated | | | |
| Example E12 | Silica | Carbonyl iron | BTA | — | — | 2.0 | 0.036 | Not | Allowable | Allowable | Good |
| | (100 nm) | (5 μm) | | | | | | generated | | | |
| Example E13 | Silica | Carbonyl iron | BTA | — | — | 9.5 | 0.050 | Not | Good | Good | Good |
| | (100 nm) | (5 μm) | | | | | | generated | | | |
| Example E14 | Silica | Carbonyl iron | BTA | 0.01 | — | 9.5 | 0.060 | Not | Good | Good | Good |
| | (100 nm) | (5 μm) | | | | | | generated | | | |
| Example E15 | Alumina | Carbonyl iron | BTA | — | — | 9.5 | 0.100 | Not | Good | Good | Good |
| | (300 nm) | (5 μm) | | | | | | generated | | | |
| Example E16 | Silica | Carbonyl iron | Ethylenediamine | — | — | 9.5 | 0.035 | Not | Good | Good | Good |
| | (100 nm) | (5 μm) | | | | | | generated | | | |
| Example E17 | Silica | Carbonyl iron | Triethylene- | — | — | 9.5 | 0.040 | Not | Good | Good | Good |
| | (100 nm) | (5 μm) | tetramine | | | | | generated | | | |
| Example E18 | Silica | Carbonyl iron | Diethylene- | — | — | 9.5 | 0.042 | Not | Good | Good | Good |
| | (100 nm) | (5 μm) | triamine | | | | | generated | | | |
| Example E19 | Silica | Carbonyl iron | Nitrilotri- | — | — | 9.5 | 0.038 | Not | Good | Good | Good |
| | (100 nm) | (5 μm) | methylene | | | | | generated | | | |
| | | | phosphonic acid | | | | | | | | |
| Comparative | Silica | Carbonyl iron | — | — | — | 9.5 | 0.038 | Generated | Poor | Poor | Poor |
| Example E1 | (100 nm) | (5 μm) | | | | | | | | | |
| Comparative | Alumina | Carbonyl iron | — | — | — | 9.5 | 0.084 | Generated | Poor | Poor | Poor |
| Example E2 | (300 nm) | (10 μm) | | | | | | | | | |
| Comparative | Alumina | Atomized iron | — | — | — | 9.5 | 0.085 | Generated | Poor | Poor | Poor |
| Example E3 | (300 nm) | (50 μm) | | | | | | | | | |

TABLE 18

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example F1 | Silica | Carbonyl iron | OSAA | — | — | 9.5 | 0.004 | Not | Good | Good | Do not |
| | (20 nm) | (3 μm) | | | | | | generated | | | occur |
| Example F2 | Silica | Carbonyl iron | OSAA | — | — | 9.5 | 0.007 | Not | Good | Good | Do not |
| | (25 nm) | (3 μm) | | | | | | generated | | | occur |
| Example F3 | Silica | Carbonyl iron | OSAA | — | — | 9.5 | 0.034 | Not | Good | Good | Do not |
| | (45 nm) | (3 μm) | | | | | | generated | | | occur |
| Example F4 | Silica | Carbonyl iron | OSAA | — | — | 9.5 | 0.065 | Not | Good | Good | Do not |
| | (100 nm) | (3 μm) | | | | | | generated | | | occur |
| Example F5 | Silica | Carbonyl iron | OSAA | — | — | 9.5 | 0.068 | Not | Good | Good | Do not |
| | (135 nm) | (3 μm) | | | | | | generated | | | occur |
| Example F6 | Silica | Carbonyl iron | OSAA | — | — | 9.5 | 0.100 | Not | Good | Good | Do not |
| | (250 nm) | (3 μm) | | | | | | generated | | | occur |
| Example F7 | Silica | Carbonyl iron | OSAA | — | — | 9.5 | 0.105 | Not | Good | Allowable | Allowable |
| | (400 nm) | (3 μm) | | | | | | generated | | | |
| Example F8 | Alumina | Carbonyl iron | OSAA | — | — | 9.5 | 0.070 | Not | Good | Good | Do not |
| | (300 nm) | (3 μm) | | | | | | generated | | | occur |
| Example F9 | Alumina | Carbonyl iron | OSAA | — | — | 9.5 | 0.085 | Not | Good | Good | Do not |
| | (500 nm) | (3 μm) | | | | | | generated | | | occur |
| Example F10 | Alumina | Carbonyl iron | OSAA | — | — | 9.5 | 0.155 | Not | Good | Allowable | Allowable |
| | (1,300 nm) | (3 μm) | | | | | | generated | | | |
| Example F11 | Alumina | Carbonyl iron | OSAA | — | — | 9.5 | 0.202 | Not | Good | Allowable | Occur |
| | (4,000 nm) | (3 μm) | | | | | | generated | | | |
| Example F12 | Alumina | Carbonyl iron | OSAA | — | — | 9.5 | 0.403 | Not | Allowable | Poor | Occur |
| | (8,000 nm) | (3 μm) | | | | | | generated | | | |
| Example F13 | Alumina | Carbonyl iron | OSAA | — | — | 9.5 | 0.484 | Not | Allowable | Poor | Occur |
| | (12,000 nm) | (3 μm) | | | | | | generated | | | |

TABLE 19

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example F14 | Silica | Carbonyl iron | OSAA | — | — | 9.5 | 0.029 | Not | Good | Good | Do not |
| | (100 nm) | (1.6 μm) | | | | | | generated | | | occur |
| Example F15 | Silica | Carbonyl iron | OSAA | — | — | 9.5 | 0.065 | Not | Good | Good | Do not |
| | (100 nm) | (3 μm) | | | | | | generated | | | occur |
| Example F16 | Silica | Carbonyl iron | OSAA | — | — | 9.5 | 0.070 | Not | Good | Good | Do not |
| | (100 nm) | (5 μm) | | | | | | generated | | | occur |
| Example F17 | Silica | Carbonyl iron | OSAA | — | — | 9.5 | 0.390 | Not | Good | Good | Do not |
| | (100 nm) | (10 μm) | | | | | | generated | | | occur |
| Example F18 | Silica | Atomized iron | OSAA | — | — | 9.5 | 0.585 | Not | Good | Allowable | Allowable |
| | (100 nm) | (20 μm) | | | | | | generated | | | |
| Example F19 | Silica | Atomized iron | OSAA | — | — | 9.5 | 0.995 | Not | Allowable | Poor | Occur |
| | (100 nm) | (50 μm) | | | | | | generated | | | |
| Example F20 | Silica | Atomized iron | OSAA | — | — | 9.5 | 1.094 | Not | Allowable | Poor | Occur |
| | (100 nm) | (100 μm) | | | | | | generated | | | |
| Example F21 | Alumina | Carbonyl iron | OSAA | — | — | 9.5 | 0.035 | Not | Good | Good | Do not |
| | (300 nm) | (1.6 μm) | | | | | | generated | | | occur |
| Example F22 | Alumina | Carbonyl iron | OSAA | — | — | 9.5 | 0.070 | Not | Good | Good | Do not |
| | (300 nm) | (3 μm) | | | | | | generated | | | occur |
| Example F23 | Alumina | Carbonyl iron | OSAA | — | — | 9.5 | 0.085 | Not | Good | Poor | Occur |
| | (300 nm) | (5 μm) | | | | | | generated | | | |
| Example F24 | Alumina | Carbonyl iron | OSAA | — | — | 9.5 | 0.975 | Not | Good | Poor | Occur |
| | (300 nm) | (10 μm) | | | | | | generated | | | |
| Example F25 | Alumina | Atomized iron | OSAA | — | — | 9.5 | 1.268 | Not | Allowable | Poor | Occur |
| | (300 nm) | (20 μm) | | | | | | generated | | | |
| Example F26 | Alumina | Atomized iron | OSAA | — | — | 9.5 | 2.535 | Not | Allowable | Poor | Occur |
| | (300 nm) | (50 μm) | | | | | | generated | | | |
| Example F27 | Alumina | Atomized iron | OSAA | — | — | 9.5 | 3.042 | Not | Allowable | Poor | Occur |
| | (300 nm) | (100 μm) | | | | | | generated | | | |

TABLE 20

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example F28 | Silica | Carbonyl iron | PT | — | — | 9.5 | 0.024 | Not | Good | Good | Do not |
| | (100 nm) | (1.6 μm) | | | | | | generated | | | occur |
| Example F29 | Silica | Carbonyl iron | PT | — | — | 9.5 | 0.051 | Not | Good | Good | Do not |
| | (100 nm) | (3 μm) | | | | | | generated | | | occur |
| Example F30 | Silica | Carbonyl iron | PT | — | — | 9.5 | 0.055 | Not | Good | Good | Do not |
| | (100 nm) | (5 μm) | | | | | | generated | | | occur |
| Example F31 | Silica | Carbonyl iron | PT | — | — | 9.5 | 0.277 | Not | Good | Good | Allowable |
| | (100 nm) | (10 μm) | | | | | | generated | | | |
| Example F32 | Silica | Atomized iron | PT | — | — | 9.5 | 0.415 | Not | Good | Allowable | Occur |
| | (100 nm) | (20 μm) | | | | | | generated | | | |
| Example F33 | Silica | Atomized iron | PT | — | — | 9.5 | 0.706 | Not | Allowable | Poor | Occur |
| | (100 nm) | (50 μm) | | | | | | generated | | | |
| Example F34 | Silica | Atomized iron | PT | — | — | 9.5 | 0.777 | Not | Allowable | Poor | Occur |
| | (100 nm) | (100 μm) | | | | | | generated | | | |
| Example F35 | Silica | Carbonyl iron | BTA | — | — | 9.5 | 0.015 | Not | Good | Good | Do not |
| | (100 nm) | (1.6 μm) | | | | | | generated | | | occur |
| Example F36 | Silica | Carbonyl iron | BTA | — | — | 9.5 | 0.053 | Not | Good | Good | Do not |
| | (100 nm) | (3 μm) | | | | | | generated | | | occur |
| Example F37 | Silica | Carbonyl iron | BTA | — | — | 9.5 | 0.054 | Not | Good | Good | Do not |
| | (100 nm) | (5 μm) | | | | | | generated | | | occur |
| Example F38 | Silica | Carbonyl iron | BTA | — | — | 9.5 | 0.312 | Not | Good | Good | Do not |
| | (100 nm) | (10 μm) | | | | | | generated | | | occur |
| Example F39 | Silica | Atomized iron | BTA | — | — | 9.5 | 0.468 | Not | Good | Allowable | Occur |
| | (100 nm) | (20 μm) | | | | | | generated | | | |
| Example F40 | Silica | Atomized iron | BTA | — | — | 9.5 | 0.796 | Not | Allowable | Poor | Occur |
| | (100 nm) | (50 μm) | | | | | | generated | | | |
| Example F41 | Silica | Atomized iron | BTA | — | — | 9.5 | 0.875 | Not | Allowable | Poor | Occur |
| | (100 nm) | (100 μm) | | | | | | generated | | | |

TABLE 21

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example F42 | Silica | Carbonyl iron | BTA | — | — | 9.5 | 0.040 | Not | Good | Good | Do not |
| | (45 nm) | (3 μm) | | | | | | generated | | | occur |
| Example F43 | Silica | Carbonyl iron | BTA | — | — | 9.5 | 0.053 | Not | Good | Good | Do not |
| | (100 nm) | (3 μm) | | | | | | generated | | | occur |
| Example F44 | Silica | Carbonyl iron | BTA | — | — | 9.5 | 0.105 | Not | Good | Good | Do not |
| | (135 nm) | (3 μm) | | | | | | generated | | | occur |
| Example F45 | Alumina | Carbonyl iron | BTA | — | — | 9.5 | 0.055 | Not | Good | Good | Do not |
| | (300 nm) | (3 μm) | | | | | | generated | | | occur |
| Example F46 | Silica | Carbonyl iron | Ethylenediamine | — | — | 9.5 | 0.058 | Not | Good | Good | Do not |
| | (100 nm) | (3 μm) | | | | | | generated | | | occur |
| Example F47 | Silica | Carbonyl iron | Triethylene- | — | — | 9.5 | 0.055 | Not | Good | Good | Do not |
| | (100 nm) | (3 μm) | tetramine | | | | | generated | | | occur |
| Example F48 | Silica | Carbonyl iron | Diethylene- | — | — | 9.5 | 0.055 | Not | Good | Good | Do not |
| | (100 nm) | (3 μm) | triamine | | | | | generated | | | occur |
| Example F49 | Silica | Carbonyl iron | Nitrilotri- | — | — | 9.5 | 0.065 | Not | Good | Good | Do not |
| | (100 nm) | (3 μm) | methylene | | | | | generated | | | occur |
| | | | phosphonic acid | | | | | | | | |
| Example F50 | — | Carbonyl iron | OSAA | — | — | 9.5 | 0.098 | Not | Good | Good | Allowable |
| | | (3 μm) | | | | | | generated | | | |
| Example F51 | — | Carbonyl iron | PT | — | — | 9.5 | 0.071 | Not | Good | Good | Allowable |
| | | (3 μm) | | | | | | generated | | | |
| Example F52 | — | Carbonyl iron | BTA | — | — | 9.5 | 0.079 | Not | Good | Good | Allowable |
| | | (3 μm) | | | | | | generated | | | |
| Example F53 | — | Carbonyl iron | Nitrilotri- | — | — | 9.5 | 0.104 | Not | Good | Good | Allowable |
| | | (3 μm) | methylene | | | | | generated | | | |
| | | | phosphonic acid | | | | | | | | |
| Comparative | Silica | Carbonyl iron | — | — | — | 9.5 | 0.071 | Generated | Poor | Poor | Occur |
| Example F1 | (100 nm) | (3 μm) | | | | | | | | | |
| Comparative | Silica | Atomized iron | — | — | — | 9.5 | 0.100 | Generated | Poor | Poor | Occur |
| Example F2 | (100 nm) | (20 μm) | | | | | | | | | |
| Comparative | Silica | Atomized iron | — | — | — | 9.5 | 0.240 | Generated | Poor | Poor | Occur |
| Example F3 | (100 nm) | (100 μm) | | | | | | | | | |
| Comparative | Silica | Carbonyl iron | Sodium | — | — | 9.5 | 0.071 | Generated | Poor | Allowable | Allowable |
| Example F4 | (100 nm) | (3 μm) | oleate | | | | | | | | |
| Comparative | Silica | Carbonyl iron | Monobutyl | — | — | 9.5 | 0.075 | Generated | Poor | Poor | Poor |
| Example F5 | (100 nm) | (3 μm) | phosphate | | | | | | | | |

TABLE 22

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example G1 | Silica | Carbonyl iron | OSAA | — | — | 9.5 | 0.059 | Not | Good | Good | Do not |
| | (100 nm) | (1.6 μm) | | | | | | generated | | | occur |
| Example G2 | Silica | Carbonyl iron | OSAA | — | — | 9.5 | 0.130 | Not | Good | Good | Do not |
| | (100 nm) | (3 μm) | | | | | | generated | | | occur |
| Example G3 | Silica | Carbonyl iron | OSAA | — | — | 9.5 | 0.139 | Not | Good | Good | Do not |
| | (100 nm) | (5 μm) | | | | | | generated | | | occur |
| Example G4 | Silica | Carbonyl iron | OSAA | — | — | 9.5 | 0.251 | Not | Good | Good | Allowable |
| | (100 nm) | (10 μm) | | | | | | generated | | | |
| Example G5 | Silica | Atomized iron | OSAA | — | — | 9.5 | 0.446 | Not | Good | Allowable | Occur |
| | (100 nm) | (20 μm) | | | | | | generated | | | |
| Example G6 | Silica | Atomized iron | OSAA | — | — | 9.5 | 0.758 | Not | Allowable | Poor | Occur |
| | (100 nm) | (50 μm) | | | | | | generated | | | |
| Example G7 | Silica | Atomized iron | OSAA | — | — | 9.5 | 1.114 | Not | Allowable | Poor | Occur |
| | (100 nm) | (100 μm) | | | | | | generated | | | |
| Example G8 | Silica | Carbonyl iron | PT | — | — | 9.5 | 0.048 | Not | Good | Good | Do not |
| | (100 nm) | (1.6 μm) | | | | | | generated | | | occur |
| Example G9 | Silica | Carbonyl iron | PT | — | — | 9.5 | 0.110 | Not | Good | Good | Do not |
| | (100 nm) | (3 μm) | | | | | | generated | | | occur |
| Example G10 | Silica | Carbonyl iron | PT | — | — | 9.5 | 0.130 | Not | Good | Good | Do not |
| | (100 nm) | (5 μm) | | | | | | generated | | | occur |
| Example G11 | Silica | Carbonyl iron | PT | — | — | 9.5 | 0.240 | Not | Good | Good | Allowable |
| | (100 nm) | (10 μm) | | | | | | generated | | | |
| Example G12 | Silica | Atomized iron | PT | — | — | 9.5 | 0.410 | Not | Good | Allowable | Occur |
| | (100 nm) | (20 μm) | | | | | | generated | | | |
| Example G13 | Silica | Atomized iron | PT | — | — | 9.5 | 0.700 | Not | Allowable | Poor | Occur |
| | (100 nm) | (50 μm) | | | | | | generated | | | |
| Example G14 | Silica | Atomized iron | PT | — | — | 9.5 | 0.950 | Not | Allowable | Poor | Occur |
| | (100 nm) | (100 μm) | | | | | | generated | | | |
| Example G15 | Silica | Carbonyl iron | BTA | — | — | 9.5 | 0.030 | Not | Good | Good | Do not |
| | (100 nm) | (1.6 μm) | | | | | | generated | | | occur |
| Example G16 | Silica | Carbonyl iron | BTA | — | — | 9.5 | 0.105 | Not | Good | Good | Do not |
| | (100 nm) | (3 μm) | | | | | | generated | | | occur |
| Example G17 | Silica | Carbonyl iron | BTA | — | — | 9.5 | 0.107 | Not | Good | Good | Do not |
| | (100 nm) | (5 μm) | | | | | | generated | | | occur |
| Example G18 | Silica | Carbonyl iron | BTA | — | — | 9.5 | 0.160 | Not | Good | Good | Do not |
| | (100 nm) | (10 μm) | | | | | | generated | | | occur |
| Example G19 | Silica | Atomized iron | BTA | — | — | 9.5 | 0.310 | Not | Good | Allowable | Occur |
| | (100 nm) | (20 μm) | | | | | | generated | | | |
| Example G20 | Silica | Atomized iron | BTA | — | — | 9.5 | 0.480 | Not | Allowable | Poor | Occur |
| | (100 nm) | (50 μm) | | | | | | generated | | | |
| Example G21 | Silica | Atomized iron | BTA | — | — | 9.5 | 0.620 | Not | Allowable | Poor | Occur |
| | (100 nm) | (100 μm) | | | | | | generated | | | |

TABLE 23

| | Polishing composition | | | | | | Evaluation result | | | | |
|---|---|---|---|---|---|---|---|---|---|---|---|
| | | | | | Water- | | Polishing | | | | |
| | Abrasive | Magnetic | | | soluble | | removal | Hydrogen | Redispers- | | |
| | particles | particles | Antioxidant | Oxidant | polymer | pH | rate | gas | ibility | Gloss | Damages |
| Example G22 | Alumina | Carbonyl iron | OSAA | — | — | 9.5 | 0.113 | Not | Good | Good | Do not |
| | (300 nm) | (1.6 μm) | | | | | | generated | | | occur |
| Example G23 | Alumina | Carbonyl iron | OSAA | — | — | 9.5 | 0.250 | Not | Good | Allowable | Allowable |
| | (300 nm) | (3 μm) | | | | | | generated | | | |
| Example G24 | Alumina | Carbonyl iron | OSAA | — | — | 9.5 | 0.268 | Not | Good | Allowable | Occur |
| | (300 nm) | (5 μm) | | | | | | generated | | | |
| Example G25 | Alumina | Carbonyl iron | OSAA | — | — | 9.5 | 0.600 | Not | Good | Poor | Occur |
| | (300 nm) | (10 μm) | | | | | | generated | | | |
| Example G26 | Alumina | Atomized iron | OSAA | — | — | 9.5 | 0.720 | Not | Good | Poor | Occur |
| | (300 nm) | (20 μm) | | | | | | generated | | | |
| Example G27 | Alumina | Atomized iron | OSAA | — | — | 9.5 | 1.457 | Not | Allowable | Poor | Occur |
| | (300 nm) | (50 μm) | | | | | | generated | | | |
| Example G28 | Alumina | Atomized iron | OSAA | — | — | 9.5 | 2.143 | Not | Allowable | Poor | Occur |
| | (300 nm) | (100 μm) | | | | | | generated | | | |
| Example G29 | Alumina | Carbonyl iron | BTA | — | — | 9.5 | 0.230 | Not | Good | Allowable | Allowable |
| | (300 nm) | (3 μm) | | | | | | generated | | | |
| Example G30 | Silica | Carbonyl iron | Ethylenediamine | — | — | 9.5 | 0.115 | Not | Good | Good | Do not |
| | (100 nm) | (3 μm) | | | | | | generated | | | occur |
| Example G31 | Silica | Carbonyl iron | Triethylene- | — | — | 9.5 | 0.110 | Not | Good | Good | Do not |
| | (100 nm) | (3 μm) | tetramine | | | | | generated | | | occur |
| Example G32 | Silica | Carbonyl iron | Diethylene- | — | — | 9.5 | 0.110 | Not | Good | Good | Do not |
| | (100 nm) | (3 μm) | triamine | | | | | generated | | | occur |
| Example G33 | Silica | Carbonyl iron | Nitrilotri- | — | — | 9.5 | 0.130 | Not | Good | Good | Do not |
| | (100 nm) | (3 μm) | methylene | | | | | generated | | | occur |
| | | | phosphonic acid | | | | | | | | |
| Comparative | Silica | Carbonyl iron | — | — | — | 9.5 | 0.143 | Generated | Poor | Poor | Occur |
| Example G1 | (100 nm) | (3 μm) | | | | | | | | | |
| Comparative | Silica | Carbonyl iron | Sodium | — | — | 9.5 | 0.142 | Generated | Poor | Allowable | Allowable |
| Example G2 | (100 nm) | (3 μm) | oleate | | | | | | | | |
| Comparative | Silica | Carbonyl iron | Monobutyl | — | — | 9.5 | 0.150 | Generated | Poor | Poor | Poor |
| Example G3 | (100 nm) | (3 μm) | phosphate | | | | | | | | |

Magnetic polishing was carried out using these polishing compositions. A polishing apparatus used is an apparatus obtained by remodeling a CNC grinding machine manufactured by EGURO Corporation, and a structure thereof is the same as that illustrated in FIG. 1. In addition, the object to be polished is a test piece made of aluminum having an anodized film, a test piece made of brass C2600, a test piece made of brass C2801, a test piece made of SUS304, a test piece made of SUS316, a test piece made of aluminum 6063, or a test piece made of polyphenylene sulfone (PPSU). These test pieces are square-shaped plates with a side of 60 mm and a thickness of 8 mm. Polishing conditions are as follows.

The test results in a case where the object to be polished is the test piece made of aluminum having an anodized film are shown in Tables 9 to 13, the test results in a case of the test piece made of brass C2600 are shown in Table 14, the test results in a case of the test piece made of brass C2801 are shown in Table 15, the test results in a case of the test piece made of SUS304 are shown in Table 16, the test results in a case of the test piece made of SUS316 are shown in Table 17, the test results in a case of the test piece made of aluminum 6063 are shown in Tables 18 to 21, and the test results in a case of the test piece made of polyphenylene sulfone (PPSU) are shown in Tables 22 and 23, respectively.

<Polishing Conditions>

Distance between the object to be polished and the surface of the polishing platen: 2 mm

Revolutional speed: 10 rpm

Rotational speed: 250 rpm

Amount of polishing composition used: 600 g

Polishing time: 30 min

Surface magnetic flux density of permanent magnet: 350 mT

As shown in Tables 7 to 23, in a case where the polishing composition of each example is used, a high polishing removal rate was exhibited, it was possible to prevent generation of hydrogen gas, and redispersibility of the aggregated magnetic particles was good. Furthermore, in a case where an average primary particle diameter of iron powders which are the magnetic particles is 10 μm or less, a suitable polished surface of the object to be polished in which gloss of the polished surface was good and damages did not occur was obtained. On the contrary, in a case where the polishing compositions of the comparative examples are used, it can be seen that hydrogen gas was generated, and thus it was not possible to prevent oxidation of the magnetic particles. In addition, the redispersibility of the aggregated magnetic particles was insufficient.

### REFERENCE SIGNS LIST

1: Polishing composition
3: Magnetic cluster
5: Object to be polished

1. A polishing composition comprising:
magnetic particles;
an antioxidant for suppressing oxidation of the magnetic particles; and
water.

2. The polishing composition according to claim 1, further comprising:
non-magnetic abrasive particles.

3. The polishing composition according to claim 1, wherein the antioxidant is at least one of an alkenyl succinic acid derivative, a bipyridine derivative, a phenanthroline derivative, a triazole derivative, a benzotriazole derivative, and an amine having no carbon-carbon multiple bond in a molecule.

4. The polishing composition according to claim 3, wherein the alkenyl succinic acid derivative includes a compound represented by Formula (1), (2), or (3), 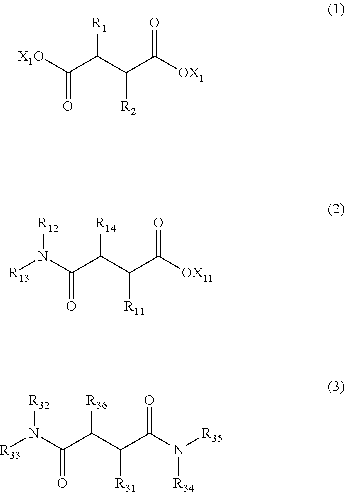
R₁ and R₂ in the compound represented by Formula (1) each independently represent a hydrogen atom or a linear or branched alkenyl group having 20 or fewer carbon atoms, X₁ each independently represents a hydrogen atom or a cation, and R₁ and R₂ do not become hydrogen atoms at the same time,
R₁₁ and R₁₄ in the compound represented by Formula (2) each independently represent a hydrogen atom or a linear or branched alkenyl group having 20 or fewer carbon atoms, R₁₂ and R₁₃ each independently represent a hydrogen atom, an alkyl group having 10 or fewer carbon atoms, an alkenyl group having 10 or fewer carbon atoms, a hydroxyalkyl group, a hydroxyalkenyl group, a polyoxyethylene group (—(CH₂CH₂O)ₙ—CH₂CH₂OH), or a polyoxypropylene group (—(CH₂CHCH₃O)ₘ—CH₂CHCH₃OH), R₁₁ and R₁₄ do not become hydrogen atoms at the same time, n in the above polyoxyethylene group represents an average addition molar number of an oxyethylene group which is 1 to 19, m in the above polyoxypropylene group represents an average addition molar number of an oxypropylene group which is 1 to 19, and X₁₁ in the compound represented by Formula (2) represents a hydrogen atom or a cation, and
R₃₁ and R₃₆ in the compound represented by Formula (3) each independently represent a hydrogen atom or a linear or branched alkenyl group having 20 or fewer carbon atoms, R₃₂, R₃₃, R₃₄, and R₃₅ each independently represent a hydrogen atom, an alkyl group having 10 or fewer carbon atoms, an alkenyl group having 10 or fewer carbon atoms, a hydroxyalkyl group, a hydroxyalkenyl group, a polyoxyethylene group (—(CH₂CH₂O)ᵣ—CH₂CH₂OH), or a polyoxypropylene group (—(CH₂CHCH₃O)ₛ—CH₂CHCH₃OH), R₃₁ and R₃₆ do not become hydrogen atoms at the same time, r in the polyoxyethylene group represents an average addition molar number of an oxyethylene group which is 1 to 19, and s in the above polyoxypropylene group represents an average addition molar number of an oxypropylene group which is 1 to 19.

5. The polishing composition according to claim 3, wherein the bipyridine derivative includes a compound represented by Formula (4), 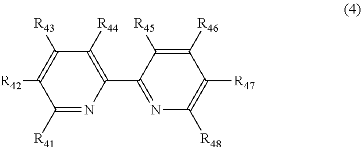
R₄₁, R₄₂, R₄₃, R₄₄, R₄₅, R₄₆, R₄₇, and R₄₈ in the compound represented by Formula (4) each independently represent a hydrogen atom, an alkyl group, an alkenyl group, a phenyl group, a hydroxyl group, an amino group, a carboxyl group, a sulfo group, a nitro group, a halogen group, a hydroxyalkyl group, a hydroxyalkenyl group, an alkylamino group, an alkenylamino group, a carboxylalkyl group, a carboxylalkenyl group, an alkylsulfo group, an alkenylsulfo group, an alkylnitro group, an alkenylnitro group, an alkoxy group, an acetyl group, an alkyl ether group, an alkenyl ether group, an alkyl halogen group, and an alkenyl halogen group.

6. The polishing composition according to claim 3, wherein the phenanthroline derivative includes a compound represented by Formula (5), 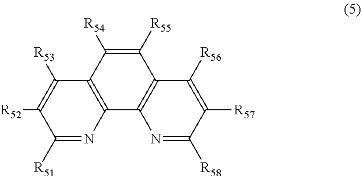
R₅₁, R₅₂, R₅₃, R₅₄, R₅₅, R₅₆, R₅₇, and R₅₈ in the compound represented by Formula (5) each independently represent a hydrogen atom, an alkyl group, an alkenyl group, a phenyl group, a hydroxyl group, an amino group, a carboxyl group, a sulfo group, a nitro group, a halogen group, a hydroxyalkyl group, a hydroxyalkenyl group, an alkylamino group, an alkenylamino group, a carboxylalkyl group, a carboxylalkenyl group, an alkylsulfo group, an alkenylsulfo group, an alkylnitro group, an alkenylnitro group, an alkoxy group, an acetyl group, an alkyl ether group, an alkenyl ether group, an alkyl halogen group, and an alkenyl halogen group.

7. The polishing composition according to claim 3,
wherein the amine having no carbon-carbon multiple bond in a molecule includes a compound represented by Formula (6), (7), (8), or (9), 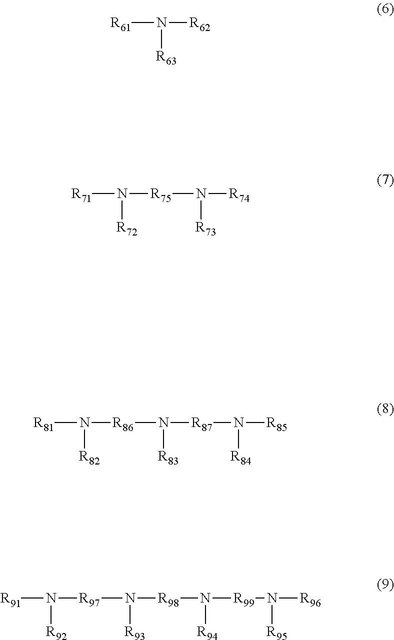
R₆₁, R₆₂, and R₆₃ in the compound represented by Formula (6) are each independently a hydrogen atom, an alkyl group, or a hydroxyalkyl group, or are each independently a carboxyalkyl group, a phosphoalkyl group, or a sulfoalkyl group, and R₆₁, R₆₂, and R₆₃ may be bonded to one another among carbon atoms to form a cyclic alkane, where three of R₆₁, R₆₂, and R₆₃ do not become hydrogen atoms at the same time,
R₇₁, R₇₂, R₇₃, and R₇₄ in the compound represented by Formula (7) each independently represent a hydrogen atom, an alkyl group, or a hydroxyalkyl group, R₇₁, R₇₂, R₇₃, and R₇₄ may be bonded to one another among carbon atoms to form a cyclic alkane, and R₇₅ in the compound represented by Formula (7) represents an alkylene group having 2 to 10 carbon atoms,
R₈₁, R₈₂, R₈₃, R₈₄, and R₈₅ in the compound represented by Formula (8) each independently represent a hydrogen atom, an alkyl group, or a hydroxyalkyl group, R₈₁, R₈₂, R₈₃, R₈₄, and R₈₅ may be bonded to one another among carbon atoms to form a cyclic alkane, and R₈₆ and R₈₇ in the compound represented by Formula (8) represent alkylene groups having 2 to 10 carbon atoms, and
R₉₁, R₉₂, R₉₃, R₉₄, R₉₅, and R₉₆ in the compound represented by Formula (9) each independently represent a hydrogen atom, an alkyl group, or a hydroxyalkyl group, R₉₁, R₉₂, R₉₃, R₉₄, R₉₅, and R₉₆ may be bonded to one another among carbon atoms to form a cyclic alkane, and R₉₇, R₉₈, and R₉₉ in the compound represented by Formula (9) represent alkylene groups having 2 to 10 carbon atoms.

8. The polishing composition according to claim 1, wherein the magnetic particles contain at least one of iron, nickel, and cobalt.

9. The polishing composition according to claim 1, having a pH of 5 to 12.

10. The polishing composition according to claim 1, having a pH of 7 to 12.

11. The polishing composition according to claim 1, which does not substantially contain an oxidant.

12. A magnetic polishing method for polishing an object to be polished by using the polishing composition according to claim 1, the method comprising:
applying a magnetic field to the polishing composition to form a magnetic cluster that contains the magnetic particles and bringing the magnetic cluster into contact with the object to be polished, to polish the object to be polished.

13. The magnetic polishing method according to claim 12, wherein the object to be polished contains at least one of an alloy and a metal oxide.

14. The magnetic polishing method according to claim 12, wherein the object to be polished contains at least one of an aluminum alloy, an iron alloy, a magnesium alloy, and a titanium alloy.

15. The magnetic polishing method according to claim 12, wherein the object to be polished contains at least one of aluminum oxide, zirconium oxide, and silicon oxide.

16. The magnetic polishing method according to claim 12, wherein, the object to be polished has a part including a surface formed of a metal oxide and the other part formed of an alloy.

17. The polishing method according to claim 12, wherein the polishing composition is produced by mixing a first component containing the magnetic particles and a second component containing the water before polishing the object to be polished, and the produced polishing composition is used to polish the object to be polished.

18. A method for producing the polishing composition according to claim 1, comprising:
mixing a first component containing the magnetic particles and a second component containing the water.

19. The polishing composition according to claim 2, wherein the antioxidant is at least one of an alkenyl succinic acid derivative, a bipyridine derivative, a phenanthroline derivative, a triazole derivative, a benzotriazole derivative, and an amine having no carbon-carbon multiple bond in a molecule.

20. The polishing composition according to claim 2, wherein the magnetic particles contain at least one of iron, nickel, and cobalt.
